(19) United States
(12) Patent Application Publication
(10) Pub. No.: US 2026/0147190 A1
(43) Pub. Date: May 28, 2026

(54) OPTICAL IMAGING SYSTEM

(71) Applicant: SAMSUNG ELECTRO-MECHANICS CO., LTD., Suwon-si (KR)

(72) Inventors: Seong Il CHO, Suwon-si (KR); Tae Yeon LIM, Suwon-si (KR); Woo Young KIM, Suwon-si (KR); Jae Hyuk HUH, Suwon-si (KR)

(73) Assignee: SAMSUNG ELECTRO-MECHANICS CO., LTD., Suwon-si (KR)

(21) Appl. No.: 19/288,413

(22) Filed: Aug. 1, 2025

(30) Foreign Application Priority Data
Nov. 27, 2024 (KR) 10-2024-0172708

(51) Int. Cl. G02B 13/00; G02B 9/62; G02B 13/02

(52) U.S. Cl. CPC G02B 13/0065; G02B 9/62; G02B 13/0045; G02B 13/02

(57) ABSTRACT

An optical imaging system includes a first lens group including a first lens and a second lens, sequentially disposed in a first optical axis direction from an object side, a second lens group including a third lens, a fourth lens, a fifth lens, and a sixth lens, sequentially disposed in a second optical axis direction, perpendicular to the first optical axis direction, and an optical path changing member disposed between the first lens group and the second lens group configured to change a propagation direction of light from the first optical axis direction to the second optical axis direction, wherein the optical imaging system satisfies a conditional expression of 0.5≤|f/f1|+|f/f2|≤2.0, where f is a focal length of the optical imaging system, f1 is a focal length of the first lens, and f2 is a focal length of the second lens.

### CROSS-REFERENCE TO RELATED APPLICATIONS

This application claims the benefit under 35 USC 119(a) of Korean Patent Application No. 10-2024-0172708 filed on Nov. 27, 2024, in the Korean Intellectual Property Office, the entire disclosure of which is incorporated herein by reference for all purposes.

### BACKGROUND

### 1. Field

The present disclosure relates to an optical imaging system for a telephoto camera.

### 2. Description of the Background

Recently, demand for slim high-magnification telephoto cameras may be increasing in the mobile camera market.

Since a high-magnification telephoto camera should have a long focal length, a prism changing a path of light may be disposed in front of a lens.

In addition, in order to implement a high-magnification camera having a low F-number, a front-view type in which a large-diameter lens may be disposed in front of the prism may be proposed.

However, when there is only one lens disposed in front of the prism, there may be a limit to aberration correction and slimming of a module height.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens group including a first lens and a second lens, sequentially disposed in a first optical axis direction from an object side, a second lens group including a third lens, a fourth lens, a fifth lens, and a sixth lens, sequentially disposed in a second optical axis direction, perpendicular to the first optical axis direction, and an optical path changing member disposed between the first lens group and the second lens group configured to change a propagation direction of light from the first optical axis direction to the second optical axis direction, wherein the optical imaging system satisfies a conditional expression of 0.5≤|f/f1|+|f/f2|≤2.0, where f is a focal length of the optical imaging system, f1 is a focal length of the first lens, and f2 is a focal length of the second lens.

The first lens and the second lens may have opposite refractive powers.

A conditional expression of 1≤fG1/f≤3 may be satisfied, where fG1 is a focal length of the first lens group.

A conditional expression of 0.3≤fG1/fG2≤2.0 may be satisfied, where fG1 is a focal length of the first lens group, and fG2 is a focal length of the second lens group.

A conditional expression of 0.5≤h2/F-number≤2 may be satisfied, where h2 is a maximum length of the second lens group in the first optical axis direction.

The third lens may have positive refractive power, the fourth lens may have negative refractive power, the fifth lens may have positive refractive power, and the sixth lens may have negative refractive power.

An image-side surface of the third lens may be concave, and an object-side surface of the fourth lens may be convex.

An image-side surface of the third lens may be convex, and an object-side surface of the fourth lens may be concave.

An object-side surface of the fifth lens may be concave, and an image-side surface of the fifth lens may be convex.

An image-side surface of the first lens and an image-side surface of the sixth lens may be concave.

An image-side surface of the first lens and an image-side surface of the sixth lens may be convex.

In another general aspect, an optical imaging system includes an optical path changing member, a first lens group disposed on an object side of the optical path changing member and including a plurality of lenses disposed in a first optical axis direction, and a second lens group disposed on an image side of the optical path changing member and including a plurality of lenses disposed in a second optical axis direction, perpendicular to the first optical axis direction, wherein the number of lenses in the second lens group is greater than the number of lenses in the first lens group, and the optical imaging system satisfies a conditional expression of 0.3≤fG1/fG2≤2.0, where fG1 is a focal length of the first lens group, and fG2 is a focal length of the second lens group.

The first lens group may include a first lens having positive refractive power and a second lens having negative refractive power, and the second lens group may include a third lens having positive refractive power, a fourth lens having negative refractive power, a fifth lens having positive refractive power, and a sixth lens having negative refractive power.

The first lens group may include a first lens having negative refractive power and a second lens having positive refractive power, and the second lens group may include a third lens having positive refractive power, a fourth lens having negative refractive power, a fifth lens having positive refractive power, and a sixth lens having negative refractive power.

A conditional expression of 1≤h1/h2≤3 may be satisfied, where h1 is a maximum length of the optical imaging system in the first optical axis direction, and h2 is a maximum length of the second lens group in the first optical axis direction.

Other features and aspects will be apparent from the following detailed description, the drawings, and the claims.

### BRIEF DESCRIPTION OF DRAWINGS

FIG. 1A is a configuration diagram of an optical imaging system according to a first embodiment of the present disclosure.

FIG. 1B is a graph illustrating aberration characteristics of an optical imaging system according to a first embodiment of the present disclosure.

FIG. 2A is a configuration diagram of an optical imaging system according to a second embodiment of the present disclosure.

FIG. 2B is a graph illustrating aberration characteristics of an optical imaging system according to a second embodiment of the present disclosure.

FIG. 3A is a configuration diagram of an optical imaging system according to a third embodiment of the present disclosure.

FIG. 3B is a graph illustrating aberration characteristics of an optical imaging system according to a third embodiment of the present disclosure.

FIG. 4A is a configuration diagram of an optical imaging system according to a fourth embodiment of the present disclosure.

FIG. 4B is a graph illustrating aberration characteristics of an optical imaging system according to a fourth embodiment of the present disclosure.

FIG. 5A is a configuration diagram of an optical imaging system according to a fifth embodiment of the present disclosure.

FIG. 5B is a graph illustrating aberration characteristics of an optical imaging system according to a fifth embodiment of the present disclosure.

FIG. 6A is a configuration diagram of an optical imaging system according to a sixth embodiment of the present disclosure.

FIG. 6B is a graph illustrating aberration characteristics of an optical imaging system according to a sixth embodiment of the present disclosure.

FIG. 7A is a configuration diagram of an optical imaging system according to a seventh embodiment of the present disclosure.

FIG. 7B is a graph illustrating aberration characteristics of an optical imaging system according to a seventh embodiment of the present disclosure.

FIG. 8A is a configuration diagram of an optical imaging system according to an eighth embodiment of the present disclosure.

FIG. 8B is a graph illustrating aberration characteristics of an optical imaging system according to an eighth embodiment of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In the present specification, a first lens means a lens closest to an object side, and a sixth lens means a lens closest to an imaging plane (or image sensor).

In addition, in the present specification, units of a curvature radius, a thickness, a distance, a focal length, and the like of the lens may be mm, and a unit of a field of view (FOV) may be ° (degrees).

In addition, in descriptions related to a shape of a lens, a convex shape on one surface means that a paraxial region (a very narrow region near and including an optical axis) portion of the one surface is convex, and a concave shape on one surface means that a paraxial region portion of the one surface is concave. Therefore, even in the case that one surface of a lens is described as having a convex shape, an edge portion of the lens may be concave. Likewise, even though one surface of a lens is described as having a concave shape, an edge portion of the lens may be convex.

BFL refers to a distance along the optical axis from the image-side surface of the sixth lens to the imaging plane. Imh refers to a maximum effective image height of the optical imaging system and is equal to one half of a diagonal length of the effective imaging area of the imaging surface of the image sensor.

An aspect of the present disclosure is to provide an optical imaging system for a telephoto camera having a low F-number.

An optical imaging system according to embodiments of the present disclosure may include six lenses. For example, an optical imaging system according to embodiments of the present disclosure may include a first lens, a second lens, a third lens, a fourth lens, a fifth lens, and a sixth lens, disposed in order from an object side.

However, an optical imaging system according to embodiments of the present disclosure may not consist of only the six lenses, and may further include other predetermined components.

An optical imaging system according to embodiments of the present disclosure may further include an image sensor converting incident light from a subject into an electrical signal.

In addition, an optical imaging system according to embodiments of the present disclosure may further include an infrared cut-off filter (hereinafter, “filter”) blocking light in an infrared region incident on the image sensor.

In addition, an optical imaging system according to embodiments of the present disclosure may further include an optical path changing member changing a path of incident light toward the image sensor. For example, the optical path changing member may be provided as a prism or mirror having a reflective surface.

In addition, an optical imaging system according to embodiments of the present disclosure may further include a stop adjusting an amount of light. For example, the stop may be disposed between two lenses disposed adjacently.

An optical imaging system according to embodiments of the present disclosure may include a lens formed of a plastic material. For example, all of the first lens to the sixth lens may be lenses formed of a plastic material.

In addition, at least one lens among the first lens to the sixth lens may have an aspherical surface. For example, each of the first lens to the sixth lens may have at least one aspherical surface. The aspherical surface of the first lens to the sixth lens may be expressed by Equation 1.

$$Z = \frac{{cY}^{2}}{1 + \sqrt{1 - ( 1 + K )} {c}^{2} {Y}^{2}} + {AY}^{4} + {BY}^{6} + {CY}^{8} + {DY}^{10} + {EY}^{12} + {FY}^{14} + {GY}^{16} + {HY}^{18} + {JY}^{18} + {JY}^{20} + {LY}^{22} + {MY}^{24} + {NY}^{26} + {OY}^{28} + {PY}^{30} … \qquad [ Equation 1 ]$$

In Equation 1, c is a curvature of a lens (reciprocal of a curvature radius), K is a conic constant, and Y is a distance from a certain point on an aspherical surface of the lens to an optical axis. In addition, constants A to H, J, and L to P are aspherical surface coefficients, and Z (or SAG) is a distance in an optical axis direction from a certain point on the aspherical surface of the lens to a vertex of the corresponding aspherical surface.

An optical imaging system according to embodiments of the present disclosure may include two lens groups. For example, an optical imaging system according to an embodiment of the present disclosure may include a first lens group and a second lens group, disposed in order from an object side.

The first lens group and the second lens group may each include a plurality of lenses disposed in different optical axis directions. For example, the first lens group may include a first lens and a second lens, disposed in order in the first optical axis direction, and the second lens group may include a third lens, a fourth lens, a fifth lens, and a sixth lens, disposed in order in the second optical axis direction, and the first optical axis direction and the second optical axis direction may be approximately perpendicular to each other.

An optical path changing member may be disposed between the first lens group and the second lens group. For example, the optical path changing member may change a path of incident light from the first optical axis direction to the second optical axis direction.

The first lens group may include lenses having opposite refractive powers. For example, the refractive powers of the first lens and the second lens may be opposite to each other. For example, the first lens may have positive refractive power and the second lens may have negative refractive power. Alternatively, the first lens may have negative refractive power and the second lens may have positive refractive power.

The second lens group may alternately have lenses having opposite refractive powers. For example, the refractive powers of adjacent two lenses may be opposite to each other. For example, the third lens may have positive refractive power, the fourth lens may have negative refractive power, the fifth lens may have positive refractive power, and the sixth lens may have negative refractive power.

According to embodiments of the present disclosure, since the first lens group and the second lens group may include a plurality of lenses, respectively, and adjacent lenses may have opposite refractive powers, aberration correction performance of the optical imaging system may be improved. In addition, since the first lens group may include a plurality of lenses, F-number may be lowered while minimizing an increase in height of a module.

An optical imaging system according to embodiments of the present disclosure may satisfy one or more of the following conditional expressions.

$$0.5 \leq \vert f / f 1 \vert + \vert f / f 2 \vert \leq 2. \qquad [ Conditional Expression 1 ]$$

$$1 \leq fG 1 / f \leq 3 \qquad [ Conditional Expression 2 ]$$

$$0.3 \leq fG 1 / fG 2 \leq 2. \qquad [ Conditional Expression 3 ]$$

$$1 \leq h 1 / h 2 \leq 3 \qquad [ Conditional Expression 4 ]$$

$$0.3 \leq dG 1 G 2 / OAL \leq 1 \qquad [ Conditional Expression 5 ]$$

$$0.5 \leq h 2 / F - number \leq 2 \qquad [ Conditional Expression 6 ]$$

In [Conditional Expression 1], f is a focal length of the optical imaging system, f1 is a focal length of the first lens, and f2 is a focal length of the second lens. [Conditional expression 1] relates to power (inverse of the focal length) conditions of the first lens and the second lens for reducing aberration of the optical imaging system.

In [Conditional expression 2], f is a focal length of the optical imaging system, and fG1 is a focal length of the first lens group (or a composite focal length of the first lens and the second lens). [Conditional expression 2] relates to power (inverse of the focal length) conditions of the first lens group for reducing a size of the second lens group.

In [Conditional expression 3], fG1 is a focal length of the first lens group, and fG2 is a focal length of the second lens group (or a composite focal length of the third lens, the fourth lens, the fifth lens, and the sixth lens). [Conditional expression 3] relates to power conditions of the first lens group and the second lens group for achieving an effect of the present disclosure.

In [Conditional Expression 4], h1 is a maximum length of the optical imaging system in the first optical axis direction, and h2 is a maximum length of the second lens group in the first optical axis direction (the first optical axis direction may correspond to a height direction of the telephoto camera module). [Conditional Expression 4] relates to a lens lead effect of the first lens group, and when a range of [Conditional Expression 4] is satisfied, it can be seen that a purpose of minimizing an increase in height of the module is achieved.

In [Conditional Expression 5], dG1G2 is a distance on an optical axis between the first lens group and the second lens group (or a sum of a distance on a first optical axis from an image-side surface of the second lens to a reflection surface and a distance on a second optical axis from the reflection surface to an object-side surface of the third lens), and OAL is a distance on the optical axis from an object-side surface of the first lens to the imaging plane. [Conditional Expression 5] relates to a lens lead effect of the first lens group, and when a range of [Conditional Expression 5] is satisfied, it can be seen that a purpose of minimizing an increase in height of the module is achieved.

In [Conditional Expression 6], h2 is a maximum length of the second lens group in the first optical axis direction. [Conditional Expression 6] relates to a lens lead effect of the first lens group, and when a range of [Conditional Expression 6] is satisfied, it can be seen as an optical imaging system having a low F-number relative to a height of the module.

An optical imaging system according to embodiments of the present disclosure may additionally satisfy one or more of the following conditional expressions.

$$- 5. < f 1 / f 2 < 0 \qquad [ Conditional Expression 7 ]$$

$$- 0.5 \leq f / f 1 \leq 1. \qquad [ Conditional Expression 8 ]$$

$$- 0.5 \leq f / f 2 \leq 1. \qquad [ Conditional Expression 9 ]$$

$$2. \leq f / f 3 \leq 3. \qquad [ Conditional Expression 10 ]$$

$$- 10 < f / f 4 \leq - 2. \qquad [ Conditional Expression 11 ]$$

$$1. \leq f / f 5 < 5. \qquad [ Conditional Expression 12 ]$$

$$- 3. \leq f / f 6 < 0 \qquad [ Conditional Expression 13 ]$$

In [Conditional Expression 7] to [Conditional Expression 13], f is a focal length of the optical imaging system, f1 is a focal length of the first lens, f2 is a focal length of the second lens, f3 is a focal length of the third lens, f4 is a focal length of the fourth lens, f5 is a focal length of the fifth lens, and f6 is a focal length of the sixth lens. When ranges of [Conditional Expression 7] to [Conditional Expression 13] are satisfied, individual lenses may have appropriate refractive power to secure aberration characteristics.

### First Embodiment

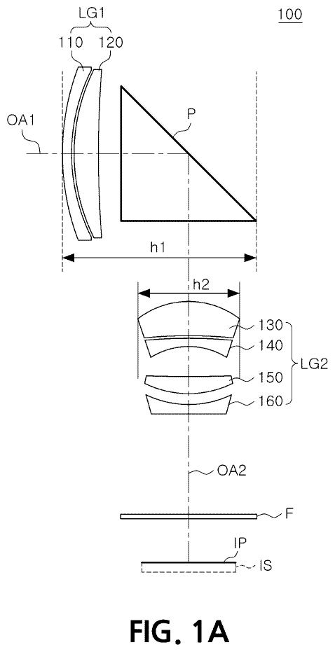

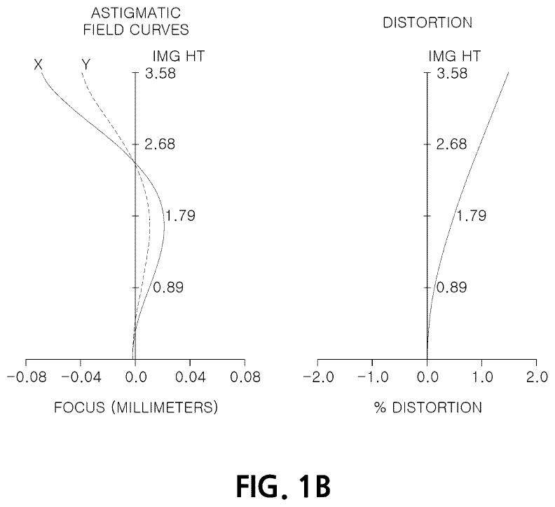

FIG. 1A is a configuration diagram of an optical imaging system according to a first embodiment of the present disclosure, and FIG. 1B is a graph illustrating aberration characteristics of an optical imaging system according to a first embodiment of the present disclosure.

An optical imaging system 100 according to a first embodiment of the present disclosure may include a first lens 110, a second lens 120, a third lens 130, a fourth lens 140, a fifth lens 150, and a sixth lens 160, disposed in order from an object side. In addition, a filter F and an image sensor IS having an imaging plane IP may be disposed on an image side of the sixth lens 160. In addition, although not illustrated in the drawing, a stop may be disposed between the fourth lens 140 and the fifth lens 150.

The optical imaging system 100 according to the first embodiment of the present disclosure may include a first lens group LG1 and a second lens group LG2, and an optical path changing member P may be disposed between the first lens group LG1 and the second lens group LG2. For example, the first lens group LG1 and the second lens group LG2 may have different optical axes.

According to the first embodiment of the present disclosure, the first lens group LG1 may include the first lens 110 and the second lens 120, arranged in a first optical axis OA1 direction. The second lens group LG2 may include the third lens 130, the fourth lens 140, the fifth lens 150, and the sixth lens 160, arranged in a second optical axis OA2 direction. The optical path changing member P may change a path of incident light incident in the first optical axis OA1 direction to the second optical axis OA2 direction.

Characteristics of each of the lenses constituting the optical imaging system 100 according to the first embodiment of the present disclosure are as illustrated in Table 1.

TABLE 1

| Surface | | Radius of | Thickness/ | Refractive | Abbe | Effective Radius | |
|---|---|---|---|---|---|---|---|
| No. | | Curvature | Distance | Index | Number | X-axis | Y-axis |
| S1 | 1^{st} Lens | 12.175 | 0.400 | 1.614 | 25.9 | 4.000 | 4.000 |
| S2 | | 8.893 | 0.105 | | | 3.880 | 3.880 |
| S3 | 2^{nd} Lens | 8.894 | 1.095 | 1.535 | 55.7 | 3.877 | 3.877 |
| S4 | | 53.944 | 1.020 | | | 3.813 | 3.813 |
| S5 | Prism | Infinity | 3.100 | 1.717 | 29.5 | | |
| S6 | | Infinity | 3.100 | 1.717 | 29.5 | | |
| S7 | | Infinity | 3.800 | | | | |
| S8 | 3^{rd} Lens | 3.812 | 1.597 | 1.535 | 55.7 | 2.300 | 1.750 |
| S9 | | 51.336 | 0.100 | | | 2.033 | 1.750 |
| S10 | 4^{th} Lens | 21.957 | 0.400 | 1.614 | 25.9 | 1.975 | 1.750 |
| S11 | | 3.163 | 1.373 | | | 1.712 | 1.750 |
| S12 | 5^{th} Lens | −44.644 | 0.799 | 1.661 | 20.4 | 1.912 | 1.750 |
| S13 | | −4.012 | 0.494 | | | 1.974 | 1.750 |
| S14 | 6^{th} Lens | −6.996 | 0.441 | 1.639 | 23.5 | 1.937 | 1.750 |
| S15 | | 14.735 | 4.661 | | | 2.200 | 1.750 |
| S16 | Filter | Infinity | 0.210 | 1.517 | 64.2 | | |
| S17 | | Infinity | 2.031 | | | | |
| S18 | Imaging | Infinity | | | | | |
| | Plane | | | | | | |

According to the first embodiment of the present disclosure, the first lens 110 may have negative refractive power, an object-side surface may be convex, and an image-side surface may be concave. The second lens 120 may have positive refractive power, an object-side surface may be convex, and an image-side surface may be concave. The third lens 130 may have positive refractive power, an object-side surface may be convex, and an image-side surface may be concave. The fourth lens 140 may have negative refractive power, an object-side surface may be convex, and an image-side surface may be concave. The fifth lens 150 may have positive refractive power, an object-side surface may be concave, and an image-side surface may be convex. The sixth lens 160 may have negative refractive power, and both an object-side surface and an image-side surface may be concave.

In addition, according to the first embodiment of the present disclosure, among the first lens 110 to the sixth lens 160, the third lens 130 may be the thickest lens, and the fifth lens 150 may be a lens having the highest refractive index. For example, a refractive index of the fifth lens 150 may be 1.65 or more. In addition, among the first lens 110 to the sixth lens 160, the third lens 130 to the sixth lens 160 may all be D-cut lenses.

Aspherical coefficients of each of the lenses constituting the optical imaging system 100 according to the first embodiment of the present disclosure are as illustrated in Table 2. According to the first embodiment, at least one of the object-side surface or the image-side surface of the first lens 110 to the sixth lens 160 may be aspherical.

TABLE 2

| Surface No. | S1 | S2 | S3 | S4 | S8 | S9 |
|---|---|---|---|---|---|---|
| Conic Constant(K) | −0.014 | −0.002 | −0.032 | 3.818 | 0.000 | 0.037 |
| 4th Coefficient(A) | −1.684E−06 | 9.719E−07 | −1.514E−05 | 1.418E−05 | 5.510E−04 | 4.471E−03 |
| 6th Coefficient(B) | 2.421E−07 | −3.195E−07 | −6.293E−07 | 1.019E−06 | 5.892E−05 | 1.090E−02 |
| 8th Coefficient(C) | 4.848E−08 | −4.250E−08 | −2.531E−08 | 6.891E−08 | −2.398E−06 | −2.033E−02 |
| 10th Coefficient(D) | 0.000E+00 | 0.000E+00 | 0.000E+00 | 0.000E+00 | −5.573E−06 | 1.793E−02 |
| 12th Coefficient(E) | 0.000E+00 | 0.000E+00 | 0.000E+00 | 0.000E+00 | 0.000E+00 | −9.595E−03 |
| 14th Coefficient(F) | 0.000E+00 | 0.000E+00 | 0.000E+00 | 0.000E+00 | 0.000E+00 | 3.198E−03 |
| 16th Coefficient(G) | 0.000E+00 | 0.000E+00 | 0.000E+00 | 0.000E+00 | 0.000E+00 | −6.478E−04 |
| 18th Coefficient(H) | 0.000E+00 | 0.000E+00 | 0.000E+00 | 0.000E+00 | 0.000E+00 | 7.301E−05 |
| 20th Coefficient(J) | 0.000E+00 | 0.000E+00 | 0.000E+00 | 0.000E+00 | 0.000E+00 | −3.512E−06 |
| 22nd Coefficient(L) | 0.000E+00 | 0.000E+00 | 0.000E+00 | 0.000E+00 | 0.000E+00 | 0.000E+00 |
| 24th Coefficient(M) | 0.000E+00 | 0.000E+00 | 0.000E+00 | 0.000E+00 | 0.000E+00 | 0.000E+00 |
| 26th Coefficient(N) | 0.000E+00 | 0.000E+00 | 0.000E+00 | 0.000E+00 | 0.000E+00 | 0.000E+00 |
| 28th Coefficient(O) | 0.000E+00 | 0.000E+00 | 0.000E+00 | 0.000E+00 | 0.000E+00 | 0.000E+00 |
| 30th Coefficient(P) | 0.000E+00 | 0.000E+00 | 0.000E+00 | 0.000E+00 | 0.000E+00 | 0.000E+00 |

| Surface No. | S10 | S11 | S12 | S13 | S14 | S15 |
|---|---|---|---|---|---|---|
| Conic Constant(K) | −72.864 | −1.171 | 0.000 | −1.432 | 0.000 | 1.468 |
| 4th Coefficient(A) | −4.310E−04 | −3.531E−04 | 0.000E+00 | 8.267E−03 | −4.931E−03 | −1.495E−02 |
| 6th Coefficient(B) | 3.327E−05 | −1.864E−02 | 0.000E+00 | −4.281E−03 | −1.531E−03 | 6.824E−04 |
| 8th Coefficient(C) | 2.370E−05 | 4.173E−02 | 0.000E+00 | 3.724E−03 | −1.919E−04 | −5.700E−05 |
| 10th Coefficient(D) | 6.300E−06 | −4.548E−02 | 0.000E+00 | −3.212E−03 | 4.762E−05 | 1.149E−05 |
| 12th Coefficient(E) | 0.000E+00 | 3.022E−02 | 0.000E+00 | 1.694E−03 | 3.127E−06 | 0.000E+00 |
| 14th Coefficient(F) | 0.000E+00 | −1.248E−02 | 0.000E+00 | −5.544E−04 | 0.000E+00 | 0.000E+00 |
| 16th Coefficient(G) | 0.000E+00 | 3.127E−03 | 0.000E+00 | 1.103E−04 | 0.000E+00 | 0.000E+00 |
| 18th Coefficient(H) | 0.000E+00 | −4.359E−04 | 0.000E+00 | −1.220E−05 | 0.000E+00 | 0.000E+00 |
| 20th Coefficient(J) | 0.000E+00 | 2.592E−05 | 0.000E+00 | 5.748E−07 | 0.000E+00 | 0.000E+00 |
| 22nd Coefficient(L) | 0.000E+00 | 0.000E+00 | 0.000E+00 | 0.000E+00 | 0.000E+00 | 0.000E+00 |
| 24th Coefficient(M) | 0.000E+00 | 0.000E+00 | 0.000E+00 | 0.000E+00 | 0.000E+00 | 0.000E+00 |
| 26th Coefficient(N) | 0.000E+00 | 0.000E+00 | 0.000E+00 | 0.000E+00 | 0.000E+00 | 0.000E+00 |
| 28th Coefficient(O) | 0.000E+00 | 0.000E+00 | 0.000E+00 | 0.000E+00 | 0.000E+00 | 0.000E+00 |
| 30th Coefficient(P) | 0.000E+00 | 0.000E+00 | 0.000E+00 | 0.000E+00 | 0.000E+00 | 0.000E+00 |

### Second Embodiment

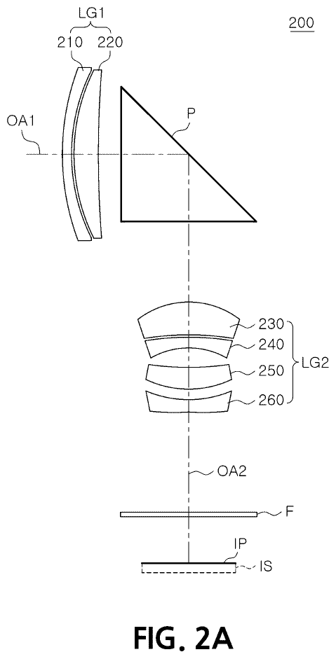

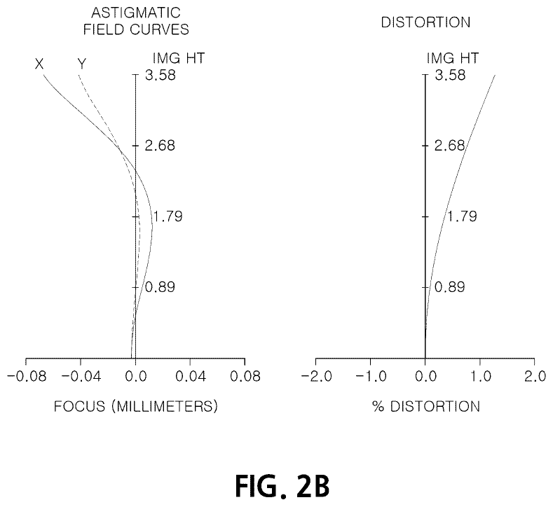

FIG. 2A is a configuration diagram of an optical imaging system according to a second embodiment of the present disclosure, and FIG. 2B is a graph illustrating aberration characteristics of an optical imaging system according to a second embodiment of the present disclosure.

An optical imaging system 200 according to a second embodiment of the present disclosure may include a first lens 210, a second lens 220, a third lens 230, a fourth lens 240, a fifth lens 250, and a sixth lens 260, disposed in order from an object side. In addition, a filter F and an image sensor IS having an imaging plane IP may be disposed on an image side of the sixth lens 260. In addition, although not illustrated in the drawing, a stop may be disposed between the fourth lens 240 and the fifth lens 250.

The optical imaging system 200 according to the second embodiment of the present disclosure may include a first lens group LG1 and a second lens group LG2, and an optical path changing member P may be disposed between the first lens group LG1 and the second lens group LG2. For example, the first lens group LG1 and the second lens group LG2 may have different optical axes.

According to the second embodiment of the present disclosure, the first lens group LG1 may include the first lens 210 and the second lens 220, arranged in a first optical axis OA1 direction. The second lens group LG2 may include the third lens 230, the fourth lens 240, the fifth lens 250, and the sixth lens 260, arranged in a second optical axis OA2 direction. The optical path changing member P may change a path of incident light incident in the first optical axis OA1 direction to the second optical axis OA2 direction.

Characteristics of each of the lenses constituting the optical imaging system 200 according to the second embodiment of the present disclosure are as illustrated in Table 3.

TABLE 3

| | | Radius of | Thickness/ | Refractive | Abbe | Effective Radius | |
|---|---|---|---|---|---|---|---|
| Surface No. | | Curvature | Distance | Index | Number | X-axis | Y-axis |
| S1 | 1^{st} Lens | 11.109 | 0.400 | 1.639 | 23.5 | 4.000 | 4.000 |
| S2 | | 8.611 | 0.111 | | | 3.866 | 3.866 |
| S3 | 2^{nd} Lens | 8.539 | 1.089 | 1.535 | 55.7 | 3.859 | 3.859 |
| S4 | | 39.449 | 1.020 | | | 3.783 | 3.783 |
| S5 | Prism | Infinity | 3.100 | 1.717 | 29.5 | | |
| S6 | | Infinity | 3.100 | 1.717 | 29.5 | | |
| S7 | | Infinity | 3.800 | | | | |
| S8 | 3^{rd} Lens | 3.794 | 1.505 | 1.535 | 55.7 | 2.300 | 1.750 |
| S9 | | 25.383 | 0.100 | | | 2.057 | 1.750 |
| S10 | 4^{th} Lens | 18.909 | 0.518 | 1.614 | 25.9 | 2.002 | 1.750 |
| S11 | | 3.323 | 0.885 | | | 1.706 | 1.750 |
| S12 | 5^{th} Lens | −12.382 | 1.000 | 1.661 | 20.4 | 1.771 | 1.750 |
| S13 | | −3.689 | 0.482 | | | 1.903 | 1.750 |
| S14 | 6^{th} Lens | −7.794 | 0.588 | 1.639 | 23.5 | 1.897 | 1.750 |
| S15 | | 20.011 | 4.661 | | | 2.200 | 1.750 |
| S16 | Filter | Infinity | 0.210 | 1.517 | 64.2 | | |
| S17 | | Infinity | 2.158 | | | | |
| S18 | Imaging | Infinity | | | | | |
| | Plane | | | | | | |

According to the second embodiment of the present disclosure, the first lens 210 may have negative refractive power, an object-side surface may be convex, and an image-side surface may be concave. The second lens 220 may have positive refractive power, an object-side surface may be convex, and an image-side surface may be concave. The third lens 230 may have positive refractive power, an object-side surface may be convex, and an image-side surface may be concave. The fourth lens 240 may have negative refractive power, an object-side surface may be convex, and an image-side surface may be concave. The fifth lens 250 may have positive refractive power, an object-side surface may be concave, and an image-side surface may be convex. The sixth lens 260 may have negative refractive power, and both an object-side surface and an image-side surface may be concave.

In addition, according to the second embodiment of the present disclosure, among the first lens 210 to the sixth lens 260, the third lens 230 may be the thickest lens, and the fifth lens 250 may be a lens having the highest refractive index. For example, a refractive index of the fifth lens 250 may be 1.65 or more. In addition, among the first lens 210 to the sixth lens 260, the third lens 230 to the sixth lens 260 may all be D-cut lenses.

Aspherical coefficients of each of the lenses constituting the optical imaging system 200 according to the second embodiment of the present disclosure are as illustrated in Table 4. According to the second embodiment, at least one of the object-side surface or the image-side surface of the first lens 210 to the sixth lens 260 may be aspherical.

TABLE 4

| Surface No. | S1 | S2 | S3 | S4 | S8 | S9 |
|---|---|---|---|---|---|---|
| Conic Constant(K) | 0.039 | −0.006 | −0.095 | 1.535 | 0.000 | 0.037 |
| 4th Coefficient(A) | 3.716E−06 | −2.881E−06 | −3.093E−05 | 7.307E−06 | 8.651E−04 | 7.312E−03 |
| 6th Coefficient(B) | 3.034E−07 | 3.470E−07 | −2.391E−07 | −5.818E−07 | 6.640E−05 | 1.398E−03 |
| 8th Coefficient(C) | 3.197E−08 | 6.146E−08 | 3.688E−08 | 3.761E−08 | −3.193E−06 | −3.765E−03 |
| 10th Coefficient(D) | 0.000E+00 | 0.000E+00 | 0.000E+00 | 0.000E+00 | −9.579E−06 | 2.673E−03 |
| 12th Coefficient(E) | 0.000E+00 | 0.000E+00 | 0.000E+00 | 0.000E+00 | 0.000E+00 | −1.249E−03 |
| 14th Coefficient(F) | 0.000E+00 | 0.000E+00 | 0.000E+00 | 0.000E+00 | 0.000E+00 | 3.698E−04 |
| 16th Coefficient(G) | 0.000E+00 | 0.000E+00 | 0.000E+00 | 0.000E+00 | 0.000E+00 | −6.560E−05 |
| 18th Coefficient(H) | 0.000E+00 | 0.000E+00 | 0.000E+00 | 0.000E+00 | 0.000E+00 | 6.362E−06 |
| 20th Coefficient(J) | 0.000E+00 | 0.000E+00 | 0.000E+00 | 0.000E+00 | 0.000E+00 | −2.595E−07 |
| 22nd Coefficient(L) | 0.000E+00 | 0.000E+00 | 0.000E+00 | 0.000E+00 | 0.000E+00 | 0.000E+00 |
| 24th Coefficient(M) | 0.000E+00 | 0.000E+00 | 0.000E+00 | 0.000E+00 | 0.000E+00 | 0.000E+00 |
| 26th Coefficient(N) | 0.000E+00 | 0.000E+00 | 0.000E+00 | 0.000E+00 | 0.000E+00 | 0.000E+00 |
| 28th Coefficient(O) | 0.000E+00 | 0.000E+00 | 0.000E+00 | 0.000E+00 | 0.000E+00 | 0.000E+00 |
| 30th Coefficient(P) | 0.000E+00 | 0.000E+00 | 0.000E+00 | 0.000E+00 | 0.000E+00 | 0.000E+00 |

| Surface No. | S10 | S11 | S12 | S13 | S14 | S15 |
|---|---|---|---|---|---|---|
| Conic Constant(K) | 10.000 | −1.143 | 0.000 | −1.458 | 0.000 | 10.000 |
| 4th Coefficient(A) | −3.397E−04 | −2.903E−03 | 0.000E+00 | 7.258E−03 | −5.111E−03 | −1.476E−02 |
| 6th Coefficient(B) | 4.089E−05 | −6.131E−03 | 0.000E+00 | −8.886E−04 | −1.435E−03 | 6.356E−04 |
| 8th Coefficient(C) | 2.488E−05 | 1.536E−02 | 0.000E+00 | −1.035E−03 | −2.157E−04 | −4.912E−05 |
| 10th Coefficient(D) | 7.169E−06 | −1.651E−02 | 0.000E+00 | 9.279E−04 | 4.656E−05 | 7.774E−06 |
| 12th Coefficient(E) | 0.000E+00 | 1.148E−02 | 0.000E+00 | 5.726E−04 | 4.108E−06 | 0.000E+00 |
| 14th Coefficient(F) | 0.000E+00 | −5.027E−03 | 0.000E+00 | 2.230E−04 | 0.000E+00 | 0.000E+00 |
| 16th Coefficient(G) | 0.000E+00 | 1.349E−03 | 0.000E+00 | −5.253E−05 | 0.000E+00 | 0.000E+00 |
| 18th Coefficient(H) | 0.000E+00 | −2.028E−04 | 0.000E+00 | 6.889E−06 | 0.000E+00 | 0.000E+00 |
| 20th Coefficient(J) | 0.000E+00 | 1.309E−05 | 0.000E+00 | −3.859E−7 | 0.000E+00 | 0.000E+00 |
| 22nd Coefficient(L) | 0.000E+00 | 0.000E+00 | 0.000E+00 | 0.000E+00 | 0.000E+00 | 0.000E+00 |
| 24th Coefficient(M) | 0.000E+00 | 0.000E+00 | 0.000E+00 | 0.000E+00 | 0.000E+00 | 0.000E+00 |
| 26th Coefficient(N) | 0.000E+00 | 0.000E+00 | 0.000E+00 | 0.000E+00 | 0.000E+00 | 0.000E+00 |
| 28th Coefficient(O) | 0.000E+00 | 0.000E+00 | 0.000E+00 | 0.000E+00 | 0.000E+00 | 0.000E+00 |
| 30th Coefficient(P) | 0.000E+00 | 0.000E+00 | 0.000E+00 | 0.000E+00 | 0.000E+00 | 0.000E+00 |

### Third Embodiment

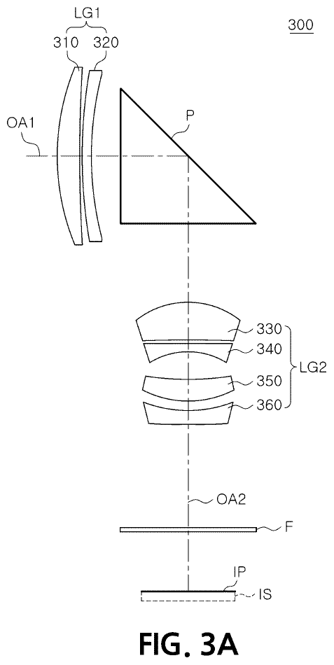

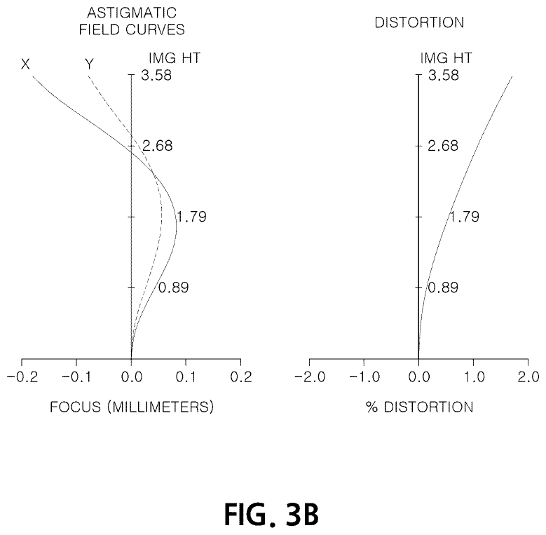

FIG. 3A is a configuration diagram of an optical imaging system according to a third embodiment of the present disclosure, and FIG. 3B is a graph illustrating aberration characteristics of an optical imaging system according to a third embodiment of the present disclosure.

An optical imaging system 300 according to a third embodiment of the present disclosure may include a first lens 310, a second lens 320, a third lens 330, a fourth lens 340, a fifth lens 350, and a sixth lens 360, disposed in order from an object side. In addition, a filter F and an image sensor IS having an imaging plane IP may be disposed on an image side of the sixth lens 360. In addition, although not illustrated in the drawings, a stop may be disposed between the fourth lens 340 and the fifth lens 350.

The optical imaging system 300 according to the third embodiment of the present disclosure may include a first lens group LG1 and a second lens group LG2, and an optical path changing member P may be disposed between the first lens group LG1 and the second lens group LG2. For example, the first lens group LG1 and the second lens group LG2 may have different optical axes.

According to the third embodiment of the present disclosure, the first lens group LG1 may include the first lens 310 and the second lens 320, arranged in a first optical axis OA1 direction. The second lens group LG2 may include the third lens 330, the fourth lens 340, the fifth lens 350, and the sixth lens 360, arranged in a second optical axis OA2 direction. The optical path changing member P may change a path of incident light incident in the first optical axis OA1 direction to the second optical axis OA2 direction.

Characteristics of each of the lenses constituting the optical imaging system 300 according to the third embodiment of the present disclosure are as illustrated in Table 5.

TABLE 5

| | | Radius of | Thickness/ | Refractive | Abbe | Effective Radius | |
|---|---|---|---|---|---|---|---|
| Surface No. | | Curvature | Distance | Index | Number | X-axis | Y-axis |
| S1 | 1^{st} Lens | 10.825 | 0.968 | 1.535 | 55.7 | 4.000 | 4.000 |
| S2 | | 61.944 | 0.132 | | | 3.930 | 3.930 |
| S3 | 2^{nd} Lens | 24.233 | 0.400 | 1.614 | 25.9 | 3.844 | 3.844 |
| S4 | | 15.417 | 1.500 | | | 3.719 | 3.719 |
| S5 | Prism | Infinity | 2.800 | 1.717 | 29.5 | | |
| S6 | | Infinity | 2.800 | 1.717 | 29.5 | | |
| S7 | | Infinity | 3.800 | | | | |
| S8 | 3^{rd} Lens | 3.657 | 1.705 | 1.535 | 55.7 | 2.300 | 1.750 |
| S9 | | −1919.355 | 0.127 | | | 2.031 | 1.750 |
| S10 | 4^{th} Lens | −1677.877 | 0.409 | 1.614 | 25.9 | 1.976 | 1.750 |
| S11 | | 3.230 | 1.226 | | | 1.709 | 1.750 |
| S12 | 5^{th} Lens | −12.283 | 1.000 | 1.661 | 20.4 | 1.861 | 1.750 |
| S13 | | −3.484 | 0.422 | | | 1.990 | 1.750 |
| S14 | 6^{th} Lens | −9.097 | 0.623 | 1.639 | 23.5 | 1.965 | 1.750 |
| S15 | | 19.272 | 4.661 | | | 2.200 | 1.750 |
| S16 | Filter | Infinity | 0.210 | 1.517 | 64.2 | | |
| S17 | | Infinity | 2.661 | | | | |
| S18 | Imaging | Infinity | | | | | |
| | Plane | | | | | | |

According to the third embodiment of the present disclosure, the first lens 310 may have positive refractive power, an object-side surface may be convex, and an image-side surface may be concave. The second lens 320 may have negative refractive power, an object-side surface may be convex, and an image-side surface may be concave. The third lens 330 may have positive refractive power, and both an object-side surface and an image-side surface may be convex. The fourth lens 340 may have negative refractive power, and both an object-side surface and an image-side surface may be concave. The fifth lens 350 may have positive refractive power, an object-side surface may be concave, and an image-side surface may be convex. The sixth lens 360 may have negative refractive power, and both an object-side surface and an image-side surface may be concave.

In addition, according to the third embodiment of the present disclosure, among the first lens 310 to the sixth lens 360, the third lens 330 may be the thickest lens, and the fifth lens 350 may be a lens having the highest refractive index. For example, a refractive index of the fifth lens 350 may be 1.65 or more. In addition, among the first lens 310 to the sixth lens 360, the third lens 330 to the sixth lens 360 may all be D-cut lenses.

Aspherical coefficients of each of the lenses constituting the optical imaging system 300 according to the third embodiment of the present disclosure are as illustrated in Table 6. According to the third embodiment, at least one of the object-side surface or the image-side surface of the first lens 310 to the sixth lens 360 may be aspherical.

TABLE 6

| Surface No. | S1 | S2 | S3 | S4 | S8 | S9 |
|---|---|---|---|---|---|---|
| Conic Constant(K) | −0.238 | 24.411 | 1.000 | −0.500 | 0.000 | 0.037 |
| 4th Coefficient(A) | −3.500E−05 | 1.390E−05 | 2.350E−05 | −1.679E−05 | 3.831E−04 | −3.178E−03 |
| 6th Coefficient(B) | −6.047E−07 | 1.169E−07 | 1.618E−06 | 8.879E−07 | 3.595E−5 | 3.440E−02 |
| 8th Coefficient(C) | 8.572E−08 | 6.847E−08 | 8.583E−08 | 1.477E−07 | −8.991E−06 | −5.023E−02 |
| 10th Coefficient(D) | 0.000E+00 | 0.000E+00 | 0.000E+00 | 0.000E+00 | −7.113E−06 | 4.018E−02 |
| 12th Coefficient(E) | 0.000E+00 | 0.000E+00 | 0.000E+00 | 0.000E+00 | 0.000E+00 | −1.999E−02 |
| 14th Coefficient(F) | 0.000E+00 | 0.000E+00 | 0.000E+00 | 0.000E+00 | 0.000E+00 | 6.266E−03 |
| 16th Coefficient(G) | 0.000E+00 | 0.000E+00 | 0.000E+00 | 0.000E+00 | 0.000E+00 | −1.202E−03 |
| 18th Coefficient(H) | 0.000E+00 | 0.000E+00 | 0.000E+00 | 0.000E+00 | 0.000E+00 | 1.288E−04 |
| 20th Coefficient(J) | 0.000E+00 | 0.000E+00 | 0.000E+00 | 0.000E+00 | 0.000E+00 | −5.912E−06 |
| 22nd Coefficient(L) | 0.000E+00 | 0.000E+00 | 0.000E+00 | 0.000E+00 | 0.000E+00 | 0.000E+00 |
| 24th Coefficient(M) | 0.000E+00 | 0.000E+00 | 0.000E+00 | 0.000E+00 | 0.000E+00 | 0.000E+00 |
| 26th Coefficient(N) | 0.000E+00 | 0.000E+00 | 0.000E+00 | 0.000E+00 | 0.000E+00 | 0.000E+00 |
| 28th Coefficient(O) | 0.000E+00 | 0.000E+00 | 0.000E+00 | 0.000E+00 | 0.000E+00 | 0.000E+00 |
| 30th Coefficient(P) | 0.000E+00 | 0.000E+00 | 0.000E+00 | 0.000E+00 | 0.000E+00 | 0.000E+00 |

| Surface No. | S10 | S11 | S12 | S13 | S14 | S15 |
|---|---|---|---|---|---|---|
| Conic Constant(K) | −1.000 | −1.218 | 0.000 | −1.357 | 0.000 | 10.000 |
| 4th Coefficient(A) | −4.068E−04 | 9.298E−03 | 0.000E+00 | 1.027E−02 | −5.125E−03 | −1.457E−02 |
| 6th Coefficient(B) | 3.520E−05 | −5.683E−02 | 0.000E+00 | −9.421E−03 | −1.564E−03 | 6.798E−04 |
| 8th Coefficient(C) | 2.111E−05 | 1.078E−01 | 0.000E+00 | 9.917E−03 | −1.905E−04 | −7.759E−05 |
| 10th Coefficient(D) | 4.550E−06 | −1.129E−01 | 0.000E+00 | −7.808E−03 | 3.774E−05 | 9.954E−06 |
| 12th Coefficient(E) | 0.000E+00 | 7.360E−02 | 0.000E+00 | 3.847E−03 | 3.087E−06 | 0.000E+00 |
| 14th Coefficient(F) | 0.000E+00 | −3.018E−02 | 0.000E+00 | −1.195E−03 | 0.000E+00 | 0.000E+00 |
| 16th Coefficient(G) | 0.000E+00 | 7.578E−03 | 0.000E+00 | 2.276E−04 | 0.000E+00 | 0.000E+00 |
| 18th Coefficient(H) | 0.000E+00 | −1.065E−03 | 0.000E+00 | −2.424E−05 | 0.000E+00 | 0.000E+00 |
| 20th Coefficient(J) | 0.000E+00 | 6.425E−05 | 0.000E+00 | 1.104E−06 | 0.000E+00 | 0.000E+00 |
| 22nd Coefficient(L) | 0.000E+00 | 0.000E+00 | 0.000E+00 | 0.000E+00 | 0.000E+00 | 0.000E+00 |
| 24th Coefficient(M) | 0.000E+00 | 0.000E+00 | 0.000E+00 | 0.000E+00 | 0.000E+00 | 0.000E+00 |
| 26th Coefficient(N) | 0.000E+00 | 0.000E+00 | 0.000E+00 | 0.000E+00 | 0.000E+00 | 0.000E+00 |
| 28th Coefficient(O) | 0.000E+00 | 0.000E+00 | 0.000E+00 | 0.000E+00 | 0.000E+00 | 0.000E+00 |
| 30th Coefficient(P) | 0.000E+00 | 0.000E+00 | 0.000E+00 | 0.000E+00 | 0.000E+00 | 0.000E+00 |

### Fourth Embodiment

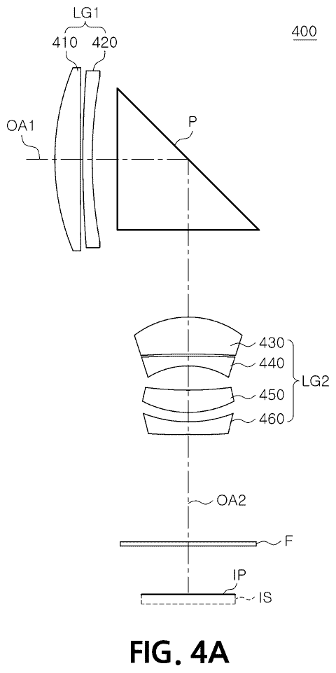

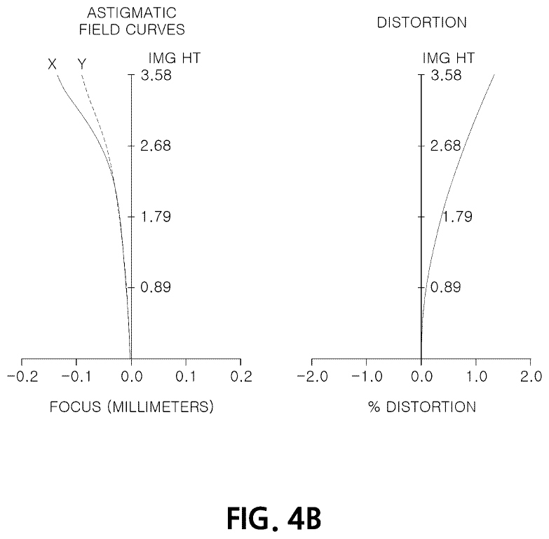

FIG. 4A is a configuration diagram of an optical imaging system according to a fourth embodiment of the present disclosure, and FIG. 4B is a graph illustrating aberration characteristics of an optical imaging system according to a fourth embodiment of the present disclosure.

An optical imaging system 400 according to a fourth embodiment of the present disclosure may include a first lens 410, a second lens 420, a third lens 430, a fourth lens 440, a fifth lens 450, and a sixth lens 460, disposed in order from an object side. In addition, a filter F and an image sensor IS having an imaging plane IP may be disposed on an image side of the sixth lens 460. In addition, although not illustrated in the drawing, a stop may be disposed between the fourth lens 440 and the fifth lens 450.

The optical imaging system 400 according to the fourth embodiment of the present disclosure may include a first lens group LG1 and a second lens group LG2, and an optical path changing member P may be disposed between the first lens group LG1 and the second lens group LG2. For example, the first lens group LG1 and the second lens group LG2 may have different optical axes.

According to the fourth embodiment of the present disclosure, the first lens group LG1 may include the first lens 410 and the second lens 420, arranged in a first optical axis OA1 direction. The second lens group LG2 may include the third lens 430, the fourth lens 440, the fifth lens 450, and the sixth lens 460, arranged in a second optical axis OA2 direction. The optical path changing member P may change a path of incident light incident in the first optical axis OA1 direction to the second optical axis OA2 direction.

Characteristics of each of the lenses constituting the optical imaging system 400 according to the fourth embodiment of the present disclosure are as illustrated in Table 7.

TABLE 7

| | | Radius of | Thickness/ | Refractive | Abbe | Effective Radius | |
|---|---|---|---|---|---|---|---|
| Surface No. | | Curvature | Distance | Index | Number | X-axis | Y-axis |
| S1 | 1^{st} Lens | 10.639 | 1.100 | 1.535 | 55.7 | 4.000 | 4.000 |
| S2 | | 678.439 | 0.100 | | | 3.929 | 3.929 |
| S3 | 2^{nd} Lens | 52.444 | 0.400 | 1.614 | 25.9 | 3.858 | 3.858 |
| S4 | | 21.106 | 1.020 | | | 3.729 | 3.729 |
| S5 | Prism | Infinity | 3.100 | 1.717 | 29.5 | | |
| S6 | | Infinity | 3.100 | 1.717 | 29.5 | | |
| S7 | | Infinity | 3.800 | | | | |
| S8 | 3^{rd} Lens | 3.715 | 1.618 | 1.535 | 55.7 | 2.300 | 1.750 |
| S9 | | 39.993 | 0.100 | | | 2.018 | 1.750 |
| S10 | 4^{th} Lens | 39.137 | 0.428 | 1.614 | 25.9 | 1.979 | 1.750 |
| S11 | | 3.231 | 1.036 | | | 1.705 | 1.750 |
| S12 | 5^{th} Lens | −14.420 | 1.000 | 1.661 | 20.4 | 1.813 | 1.750 |
| S13 | | −3.638 | 0.376 | | | 1.940 | 1.750 |
| S14 | 6^{th} Lens | −7.404 | 0.574 | 1.639 | 23.5 | 1.929 | 1.750 |
| S15 | | 27.912 | 4.661 | | | 2.200 | 1.750 |
| S16 | Filter | Infinity | 0.210 | 1.517 | 64.2 | | |
| S17 | | Infinity | 2.136 | | | | |
| S18 | Imaging | Infinity | | | | | |
| | Plane | | | | | | |

According to the fourth embodiment of the present disclosure, the first lens 410 may have positive refractive power, an object-side surface may be convex, and an image-side surface may be concave. The second lens 420 may have negative refractive power, an object-side surface may be convex, and an image-side surface may be concave. The third lens 430 may have positive refractive power, an object-side surface may be convex, and an image-side surface may be concave. The fourth lens 440 may have negative refractive power, an object-side surface may be convex, and an image-side surface may be concave. The fifth lens 450 may have positive refractive power, an object-side surface may be concave, and an image-side surface may be convex. The sixth lens 460 may have negative refractive power, and both an object-side surface and an image-side surface may be concave.

In addition, according to the fourth embodiment of the present disclosure, among the first lens 410 to the sixth lens 460, the third lens 430 may be the thickest lens, and the fifth lens 450 may be a lens having the highest refractive index. For example, a refractive index of the fifth lens 450 may be 1.65 or more. In addition, among the first lens 410 to the sixth lens 460, the third lens 430 to the sixth lens 460 may all be D-cut lenses.

Aspherical coefficients of each of the lenses constituting the optical imaging system 400 according to the fourth embodiment of the present disclosure are as illustrated in Table 8. According to the fourth embodiment, at least one of the object-side surface or the image-side surface of the first lens 410 to the sixth lens 460 may be aspherical.

TABLE 8

| Surface No. | S1 | S2 | S3 | S4 | S8 | S9 |
|---|---|---|---|---|---|---|
| Conic Constant(K) | −0.153 | −159.556 | 2.269 | −0.159 | 0.000 | 0.037 |
| 4th Coefficient(A) | −2.744E−08 | 1.455E−05 | 6.287E−06 | −4.522E−06 | 5.069E−04 | 3.699E−03 |
| 6th Coefficient(B) | −6.555E−07 | 2.457E−07 | 7.275E−07 | −8.016E−09 | 4.286E−05 | 9.215E−03 |
| 8th Coefficient(C) | 9.868E−09 | 1.359E−08 | 3.486E−08 | 4.043E−08 | −5.007E−06 | −1.350E−02 |
| 10th Coefficient(D) | 1.812E−09 | 1.784E−09 | 1.506E−09 | 2.633E−09 | −6.038E−06 | 9.815E−03 |
| 12th Coefficient(E) | 0.000E+00 | 0.000E+00 | 0.000E+00 | 0.000E+00 | 0.000E+00 | −4.526E−03 |
| 14th Coefficient(F) | 0.000E+00 | 0.000E+00 | 0.000E+00 | 0.000E+00 | 0.000E+00 | 1.333E−03 |
| 16th Coefficient(G) | 0.000E+00 | 0.000E+00 | 0.000E+00 | 0.000E+00 | 0.000E+00 | −2.411E−04 |
| 18th Coefficient(H) | 0.000E+00 | 0.000E+00 | 0.000E+00 | 0.000E+00 | 0.000E+00 | 2.435E−05 |
| 20th Coefficient(J) | 0.000E+00 | 0.000E+00 | 0.000E+00 | 0.000E+00 | 0.000E+00 | −1.051E−6 |
| 22nd Coefficient(L) | 0.000E+00 | 0.000E+00 | 0.000E+00 | 0.000E+00 | 0.000E+00 | 0.000E+00 |
| 24th Coefficient(M) | 0.000E+00 | 0.000E+00 | 0.000E+00 | 0.000E+00 | 0.000E+00 | 0.000E+00 |
| 26th Coefficient(N) | 0.000E+00 | 0.000E+00 | 0.000E+00 | 0.000E+00 | 0.000E+00 | 0.000E+00 |
| 28th Coefficient(O) | 0.000E+00 | 0.000E+00 | 0.000E+00 | 0.000E+00 | 0.000E+00 | 0.000E+00 |
| 30th Coefficient(P) | 0.000E+00 | 0.000E+00 | 0.000E+00 | 0.000E+00 | 0.000E+00 | 0.000E+00 |

| Surface No. | S10 | S11 | S12 | $13 | S14 | S15 |
|---|---|---|---|---|---|---|
| Conic Constant(K) | 10.000 | −1.135 | 0.000 | −1.438 | 0.000 | 7.316 |
| 4th Coefficient(A) | −4.428E−04 | 3.248E−03 | 0.000E+00 | 6.680E−03 | −4.915E−03 | −1.509E−02 |
| 6th Coefficient(B) | 4.883E−05 | −2.438E−02 | 0.000E+00 | 1.720E−03 | −1.632E−03 | 6.377E−04 |
| 8th Coefficient(C) | 3.227E−05 | 4.453E−02 | 0.000E+00 | −4.994E−03 | −2.592E−04 | −7.021E−05 |
| 10th Coefficient(D) | 9.562E−06 | −4.471E−02 | 0.000E+00 | 4.164E−03 | 4.490E−05 | 7.970E−06 |
| 12th Coefficient(E) | 0.000E+00 | 2.871E−02 | 0.000E+00 | −2.199E−03 | 3.087E−06 | 0.000E+00 |
| 14th Coefficient(F) | 0.000E+00 | −1.176E−02 | 0.000E+00 | 7.350E−04 | 0.000E+00 | 0.000E+00 |
| 16th Coefficient(G) | 0.000E+00 | 2.974E−03 | 0.000E+00 | −1.502E−04 | 0.000E+00 | 0.000E+00 |
| 18th Coefficient(H) | 0.000E+00 | −4.235E−04 | 0.000E+00 | 1.718E−05 | 0.000E+00 | 0.000E+00 |
| 20th Coefficient(J) | 0.000E+00 | 2.598E−05 | 0.000E+00 | −8.435E−07 | 0.000E+00 | 0.000E+00 |
| 22nd Coefficient(L) | 0.000E+00 | 0.000E+00 | 0.000E+00 | 0.000E+00 | 0.000E+00 | 0.000E+00 |
| 24th Coefficient(M) | 0.000E+00 | 0.000E+00 | 0.000E+00 | 0.000E+00 | 0.000E+00 | 0.000E+00 |
| 26th Coefficient(N) | 0.000E+00 | 0.000E+00 | 0.000E+00 | 0.000E+00 | 0.000E+00 | 0.000E+00 |
| 28th Coefficient(O) | 0.000E+00 | 0.000E+00 | 0.000E+00 | 0.000E+00 | 0.000E+00 | 0.000E+00 |
| 30th Coefficient(P) | 0.000E+00 | 0.000E+00 | 0.000E+00 | 0.000E+00 | 0.000E+00 | 0.000E+00 |

### Fifth Embodiment

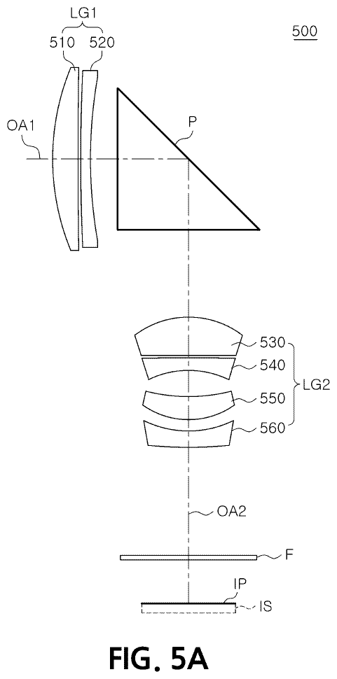

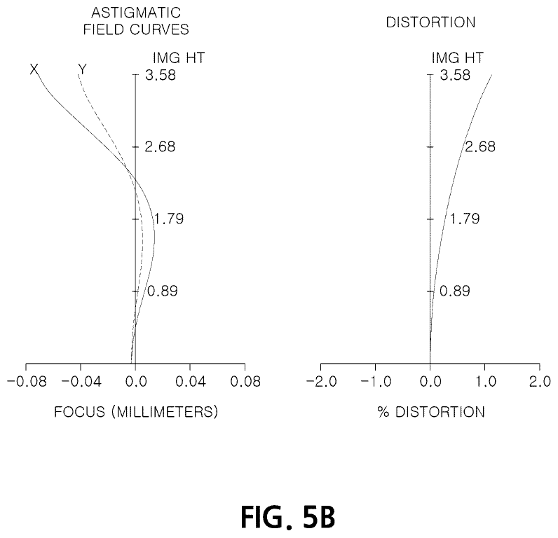

FIG. 5A is a configuration diagram of an optical imaging system according to a fifth embodiment of the present disclosure, and FIG. 5B is a graph illustrating aberration characteristics of an optical imaging system according to a fifth embodiment of the present disclosure.

An optical imaging system 500 according to a fifth embodiment of the present disclosure may include a first lens 510, a second lens 520, a third lens 530, a fourth lens 540, a fifth lens 550, and a sixth lens 560, disposed in order from an object side. In addition, a filter F and an image sensor IS having an imaging plane IP may be disposed on an image side of the sixth lens 560. In addition, although not illustrated in the drawing, a stop may be disposed between the fourth lens 540 and the fifth lens 550.

The optical imaging system 500 according to the fifth embodiment of the present disclosure may include a first lens group LG1 and a second lens group LG2, and an optical path changing member P may be disposed between the first lens group LG1 and the second lens group LG2. For example, the first lens group LG1 and the second lens group LG2 may have different optical axes.

According to the fifth embodiment of the present disclosure, the first lens group LG1 may include the first lens 510 and the second lens 520, arranged in a first optical axis OA1 direction. The second lens group LG2 may include the third lens 530, the fourth lens 540, the fifth lens 550, and the sixth lens 560, arranged in a second optical axis OA2 direction. The optical path changing member P may change a path of incident light incident in the first optical axis OA1 direction to the second optical axis OA2 direction.

Characteristics of each of the lenses constituting the optical imaging system 500 according to the fifth embodiment of the present disclosure are as illustrated in Table 9.

TABLE 9

| | | Radius of | Thickness/ | Refractive | Abbe | Effective Radius | |
|---|---|---|---|---|---|---|---|
| Surface No. | | Curvature | Distance | Index | Number | X-axis | Y-axis |
| S1 | 1^{st} Lens | 11.279 | 1.076 | 1.535 | 55.7 | 4.000 | 4.000 |
| S2 | | −430.052 | 0.100 | | | 3.927 | 3.927 |
| S3 | 2^{nd} Lens | 113.494 | 0.424 | 1.614 | 25.9 | 3.862 | 3.862 |
| S4 | | 26.924 | 1.020 | | | 3.728 | 3.728 |
| S5 | Prism | Infinity | 3.100 | 1.717 | 29.5 | | |
| S6 | | Infinity | 3.100 | 1.717 | 29.5 | | |
| S7 | | Infinity | 3.700 | | | | |
| S8 | 3^{rd} Lens | 3.889 | 1.658 | 1.535 | 55.7 | 2.300 | 1.750 |
| S9 | | 61.398 | 0.112 | | | 2.023 | 1.750 |
| S10 | 4^{th} Lens | 76.784 | 0.536 | 1.614 | 25.9 | 1.961 | 1.750 |
| S11 | | 3.923 | 1.114 | | | 1.676 | 1.750 |
| S12 | 5^{th} Lens | −6.905 | 1.000 | 1.661 | 20.4 | 1.778 | 1.750 |
| S13 | | −3.097 | 0.505 | | | 1.931 | 1.750 |
| S14 | 6^{th} Lens | −5.35 | 0.700 | 1.639 | 23.5 | 1.908 | 1.750 |
| S15 | | −724.030 | 4.661 | | | 2.200 | 1.750 |
| S16 | Filter | Infinity | 0.210 | 1.517 | 64.2 | | |
| S17 | | Infinity | 1.857 | | | | |
| S18 | Imaging | Infinity | | | | | |
| | Plane | | | | | | |

According to the fifth embodiment of the present disclosure, the first lens 510 may have positive refractive power, and both an object-side surface and an image-side surface may be convex. The second lens 520 may have negative refractive power, an object-side surface may be convex, and an image-side surface may be concave. The third lens 530 may have positive refractive power, an object-side surface may be convex, and an image-side surface may be concave. The fourth lens 540 may have negative refractive power, an object-side surface may be convex, and an image-side surface may be concave. The fifth lens 550 may have positive refractive power, an object-side surface may be concave, and an image-side surface may be convex. The sixth lens 560 may have negative refractive power, an object-side surface may be concave, and an image-side surface may be convex.

In addition, according to the fifth embodiment of the present disclosure, among the first lens 510 to the sixth lens 560, the third lens 530 may be the thickest lens, and the fifth lens 550 may be a lens having the highest refractive index. For example, a refractive index of the fifth lens 550 may be 1.65 or more. In addition, among the first lens 510 to the sixth lens 560, the third lens 530 to the sixth lens 560 may all be D-cut lenses.

Aspherical coefficients of each of the lenses constituting the optical imaging system 500 according to the fifth embodiment of the present disclosure are as illustrated in Table 10. According to the fifth embodiment, at least one of the object-side surface or the image-side surface of the first lens 510 to the sixth lens 560 may be aspherical.

TABLE 10

| Surface No. | S1 | S2 | S3 | S4 | S8 | S9 |
|---|---|---|---|---|---|---|
| Conic Constant(K) | −0.426 | 0.000 | 1.000 | −8.050 | 0.000 | 0.037 |
| 4th Coefficient(A) | −6.043E−05 | 1.310E−06 | −4.344E−06 | −2.273E−05 | 7.222E−04 | 3.414E−03 |
| 6th Coefficient(B) | −1.322E−06 | −7.46E−07 | 9.821E−07 | 3.390E−07 | 1.705E−05 | 2.348E−03 |
| 8th Coefficient(C) | 5.375E−08 | −2.192E−08 | 1.409E−08 | 1.578E−07 | −1.027E−05 | −4.986E−03 |
| 10th Coefficient(D) | 0.000E+00 | 0.000E+00 | 0.000E+00 | 0.000E+00 | −2.859E−06 | 3.739E−03 |
| 12th Coefficient(E) | 0.000E+00 | 0.000E+00 | 0.000E+00 | 0.000E+00 | 0.000E+00 | −1.782E−03 |
| 14th Coefficient(F) | 0.000E+00 | 0.000E+00 | 0.000E+00 | 0.000E+00 | 0.000E+00 | 5.431E−04 |
| 16th Coefficient(G) | 0.000E+00 | 0.000E+00 | 0.000E+00 | 0.000E+00 | 0.000E+00 | −1.014E−04 |
| 18th Coefficient(H) | 0.000E+00 | 0.000E+00 | 0.000E+00 | 0.000E+00 | 0.000E+00 | 1.055E−05 |
| 20th Coefficient(J) | 0.000E+00 | 0.000E+00 | 0.000E+00 | 0.000E+00 | 0.000E+00 | −4.679E−07 |
| 22nd Coefficient(L) | 0.000E+00 | 0.000E+00 | 0.000E+00 | 0.000E+00 | 0.000E+00 | 0.000E+00 |
| 24th Coefficient(M) | 0.000E+00 | 0.000E+00 | 0.000E+00 | 0.000E+00 | 0.000E+00 | 0.000E+00 |
| 26th Coefficient(N) | 0.000E+00 | 0.000E+00 | 0.000E+00 | 0.000E+00 | 0.000E+00 | 0.000E+00 |
| 28th Coefficient(O) | 0.000E+00 | 0.000E+00 | 0.000E+00 | 0.000E+00 | 0.000E+00 | 0.000E+00 |
| 30th Coefficient(P) | 0.000E+00 | 0.000E+00 | 0.000E+00 | 0.000E+00 | 0.000E+00 | 0.000E+00 |

| Surface No. | S10 | S11 | S12 | S13 | S14 | S15 |
|---|---|---|---|---|---|---|
| Conic Constant(K) | −1.000 | −0.670 | 0.000 | −1.104 | 0.000 | 10.000 |
| 4th Coefficient(A) | −3.192E−06 | 6.128E−05 | 0.000E+00 | 6.604E−03 | −5.527E−03 | −1.353E−02 |
| 6th Coefficient(B) | −7.146E−05 | −7.669E−03 | 0.000E+00 | −2.690E−03 | −1.340E−03 | 8.727E−04 |
| 8th Coefficient(C) | −1.823E−05 | 1.865E−02 | 0.000E+00 | 1.209E−03 | −1.050E−04 | −6.196E−05 |
| 10th Coefficient(D) | −1.169E−06 | −2.073E−02 | 0.000E+00 | −8.995E−04 | 4.576E−05 | 4.890E−06 |
| 12th Coefficient(E) | 0.000E+00 | 1.461E−02 | 0.000E+00 | 4.189E−04 | −6.275E−07 | 0.000E+00 |
| 14th Coefficient(F) | 0.000E+00 | −6.509E−03 | 0.000E+00 | −1.188E−04 | 0.000E+00 | 0.000E+00 |
| 16th Coefficient(G) | 0.000E+00 | 1.780E−03 | 0.000E+00 | 1.957E−05 | 0.000E+00 | 0.000E+00 |
| 18th Coefficient(H) | 0.000E+00 | −2.729E−04 | 0.000E+00 | −1.647E−06 | 0.000E+00 | 0.000E+00 |
| 20th Coefficient(J) | 0.000E+00 | 1.795E−05 | 0.000E+00 | 4.854E−08 | 0.000E+00 | 0.000E+00 |
| 22nd Coefficient(L) | 0.000E+00 | 0.000E+00 | 0.000E+00 | 0.000E+00 | 0.000E+00 | 0.000E+00 |
| 24th Coefficient(M) | 0.000E+00 | 0.000E+00 | 0.000E+00 | 0.000E+00 | 0.000E+00 | 0.000E+00 |
| 26th Coefficient(N) | 0.000E+00 | 0.000E+00 | 0.000E+00 | 0.000E+00 | 0.000E+00 | 0.000E+00 |
| 28th Coefficient(O) | 0.000E+00 | 0.000E+00 | 0.000E+00 | 0.000E+00 | 0.000E+00 | 0.000E+00 |
| 30th Coefficient(P) | 0.000E+00 | 0.000E+00 | 0.000E+00 | 0.000E+00 | 0.000E+00 | 0.000E+00 |

### Sixth Embodiment

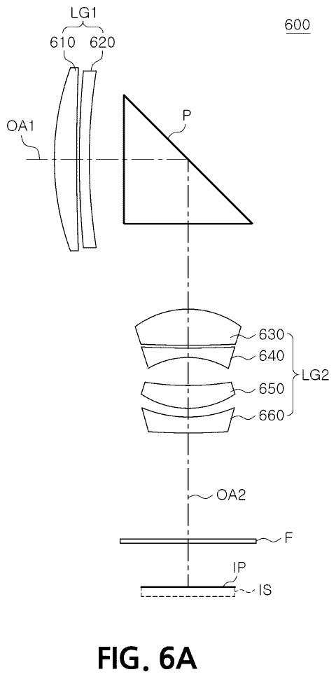

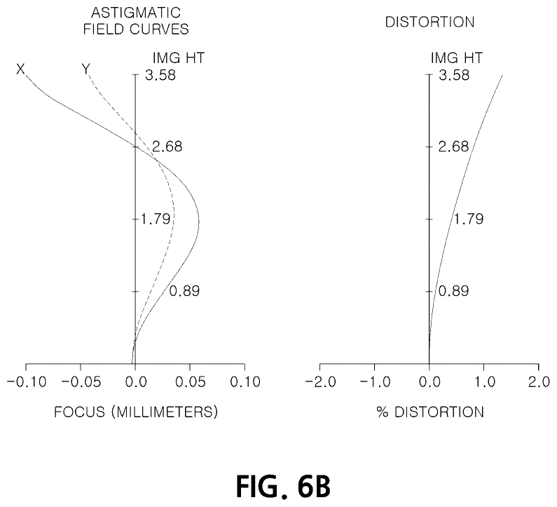

FIG. 6A is a configuration diagram of an optical imaging system according to a sixth embodiment of the present disclosure, and FIG. 6B is a graph illustrating aberration characteristics of an optical imaging system according to a sixth embodiment of the present disclosure.

An optical imaging system 600 according to a sixth embodiment of the present disclosure may include a first lens 610, a second lens 620, a third lens 630, a fourth lens 640, a fifth lens 650, and a sixth lens 660, disposed in order from an object side. In addition, a filter F and an image sensor IS having an imaging plane IP may be disposed on an image side of the sixth lens 660. In addition, although not illustrated in the drawing, a stop may be disposed between the fourth lens 640 and the fifth lens 650.

The optical imaging system 600 according to the sixth embodiment of the present disclosure may include a first lens group LG1 and a second lens group LG2, and an optical path changing member P may be disposed between the first lens group LG1 and the second lens group LG2. For example, the first lens group LG1 and the second lens group LG2 may have different optical axes.

According to the sixth embodiment of the present disclosure, the first lens group LG1 may include the first lens 610 and the second lens 620, arranged in a first optical axis OA1 direction. The second lens group LG2 may include the third lens 630, the fourth lens 640, the fifth lens 650, and the sixth lens 660, arranged in a second optical axis OA2 direction. The optical path changing member P may change a path of incident light incident in the first optical axis OA1 direction to the second optical axis OA2 direction.

Characteristics of each of the lenses constituting the optical imaging system 600 according to the sixth embodiment of the present disclosure are as illustrated in Table 11.

TABLE 11

| | | Radius of | Thickness/ | Refractive | Abbe | Effective Radius | |
|---|---|---|---|---|---|---|---|
| Surface No. | | Curvature | Distance | Index | Number | X-axis | Y-axis |
| S1 | 1^{st} Lens | 11.873 | 0.967 | 1.535 | 55.7 | 4.000 | 4.000 |
| S2 | | 131.936 | 0.100 | | | 3.937 | 3.937 |
| S3 | 2^{nd} Lens | 45.279 | 0.433 | 1.614 | 25.9 | 3.885 | 3.885 |
| S4 | | 25.373 | 1.500 | | | 3.784 | 3.784 |
| S5 | Prism | Infinity | 2.800 | 1.717 | 29.5 | | |
| S6 | | Infinity | 2.800 | 1.717 | 29.5 | | |
| S7 | | Infinity | 3.800 | | | | |
| S8 | 3^{rd} Lens | 3.687 | 1.597 | 1.535 | 55.7 | 2.300 | 1.750 |
| S9 | | −31.243 | 0.130 | | | 2.077 | 1.750 |
| S10 | 4^{th} Lens | −30.318 | 0.400 | 1.614 | 25.9 | 2.012 | 1.750 |
| S11 | | 3.082 | 1.238 | | | 1.722 | 1.750 |
| S12 | 5^{th} Lens | −12.365 | 1.000 | 1.661 | 20.4 | 1.876 | 1.750 |
| S13 | | −3.314 | 0.405 | | | 2.008 | 1.750 |
| S14 | 6^{th} Lens | −7.423 | 0.700 | 1.639 | 23.5 | 1.990 | 1.750 |
| S15 | | 37.696 | 4.661 | | | 2.200 | 1.750 |
| S16 | Filter | Infinity | 0.210 | 1.517 | 64.2 | | |
| S17 | | Infinity | 2.557 | | | | |
| S18 | Imaging | Infinity | | | | | |
| | Plane | | | | | | |

According to the sixth embodiment of the present disclosure, the first lens 610 may have positive refractive power, an object-side surface may be convex, and an image-side surface may be concave. The second lens 620 may have negative refractive power, an object-side surface may be convex, and an image-side surface may be concave. The third lens 630 may have positive refractive power, and both an object-side surface and an image-side surface may be convex. The fourth lens 640 may have negative refractive power, and both an object-side surface and an image-side surface may be concave. The fifth lens 650 may have positive refractive power, an object-side surface may be concave, and an image-side surface may be convex. The sixth lens 660 may have negative refractive power, and both an object-side surface and an image-side surface may be concave.

In addition, according to the sixth embodiment of the present disclosure, among the first lens 610 to the sixth lens 660, the third lens 630 may be the thickest lens, and the fifth lens 650 may be a lens having the highest refractive index. For example, a refractive index of the fifth lens 650 may be 1.65 or more. In addition, among the first lens 610 to the sixth lens 660, the third lens 630 to the sixth lens 660 may all be D-cut lenses.

Aspherical coefficients of each of the lenses constituting the optical imaging system 600 according to the sixth embodiment of the present disclosure are as illustrated in Table 12. According to the sixth embodiment, at least one of the object-side surface or the image-side surface of the first lens 610 to the sixth lens 660 may be aspherical.

TABLE 12

| Surface No. | S1 | S2 | S3 | S4 | S8 | S9 |
|---|---|---|---|---|---|---|
| Conic Constant(K) | −0.279 | −10.117 | 1.000 | −0.866 | 0.000 | 0.037 |
| 4th Coefficient(A) | −3.865E−05 | 1.324E−05 | 2.921E−05 | −2. 128E−05 | 4.108E−04 | 7.890E−03 |
| 6th Coefficient(B) | −1.012E−06 | −1.511E−07 | 1.695E−06 | 1.426E−06 | 4.590E−05 | 6.260E−03 |
| 8th Coefficient(C) | 1.186E−07 | 4.423E−08 | 8.606E−08 | 2.134E−07 | −9.589E−06 | −1.318E−02 |
| 10th Coefficient(D) | 0.000E+00 | 0.000E+00 | 0.000E+00 | 0.000E+00 | −7.581E−06 | 1.087E−02 |
| 12th Coefficient(E) | 0.000E+00 | 0.000E+00 | 0.000E+00 | 0.000E+00 | 0.000E+00 | −5.491E−03 |
| 14th Coefficient(F) | 0.000E+00 | 0.000E+00 | 0.000E+00 | 0.000E+00 | 0.000E+00 | 1.743E−03 |
| 16th Coefficient(G) | 0.000E+00 | 0.000E+00 | 0.000E+00 | 0.000E+00 | 0.000E+00 | −3.375E−04 |
| 18th Coefficient(H) | 0.000E+00 | 0.000E+00 | 0.000E+00 | 0.000E+00 | 0.000E+00 | 3.638E−05 |
| 20th Coefficient(J) | 0.000E+00 | 0.000E+00 | 0.000E+00 | 0.000E+00 | 0.000E+00 | −1.673E−06 |
| 22nd Coefficient(L) | 0.000E+00 | 0.000E+00 | 0.000E+00 | 0.000E+00 | 0.000E+00 | 0.000E+00 |
| 24th Coefficient(M) | 0.000E+00 | 0.000E+00 | 0.000E+00 | 0.000E+00 | 0.000E+00 | 0.000E+00 |
| 26th Coefficient(N) | 0.000E+00 | 0.000E+00 | 0.000E+00 | 0.000E+00 | 0.000E+00 | 0.000E+00 |
| 28th Coefficient(O) | 0.000E+00 | 0.000E+00 | 0.000E+00 | 0.000E+00 | 0.000E+00 | 0.000E+00 |
| 30th Coefficient(P) | 0.000E+00 | 0.000E+00 | 0.000E+00 | 0.000E+00 | 0.000E+00 | 0.000E+00 |
| Surface No. | S10 | S11 | S12 | S13 | S14 | S15 |
| Conic Constant(K) | 1.000 | −1.231 | 0.000 | −1.226 | 0.000 | 10.000 |
| 4th Coefficient(A) | −4.339E−04 | 4.280E−03 | 0.000E+00 | 8.477E−03 | −5.164E−03 | −1.414E−02 |
| 6th Coefficient(B) | 9.900E−06 | −1.058E−02 | 0.000E+00 | −5.822E−03 | −1.504E−03 | 7.667E−04 |
| 8th Coefficient(C) | 8.689E−06 | 2.723E−02 | 0.000E+00 | 4.905E−03 | −1.499E−04 | −7.350E−05 |
| 10th Coefficient(D) | 1.936E−07 | −2.916E−02 | 0.000E+00 | −3.633E−03 | 3.669E−05 | 8.452E−06 |
| 12th Coefficient(E) | 0.000E+00 | 1.923E−02 | 0.000E+00 | 1.675E−03 | 3.087E−06 | 0.000E+00 |
| 14th Coefficient(F) | 0.000E+00 | −7.935E−03 | 0.000E+00 | −4.855E−04 | 0.000E+00 | 0.000E+00 |
| 16th Coefficient(G) | 0.000E+00 | 1.995E−03 | 0.000E+00 | 8.644E−05 | 0.000E+00 | 0.000E+00 |
| 18th Coefficient(H) | 0.000E+00 | −2.797E−04 | 0.000E+00 | −8.649E−06 | 0.000E+00 | 0.000E+00 |
| 20th Coefficient(J) | 0.000E+00 | 1.676E−05 | 0.000E+00 | 3.732E−07 | 0.000E+00 | 0.000E+00 |
| 22nd Coefficient(L) | 0.000E+00 | 0.000E+00 | 0.000E+00 | 0.000E+00 | 0.000E+00 | 0.000E+00 |
| 24th Coefficient(M) | 0.000E+00 | 0.000E+00 | 0.000E+00 | 0.000E+00 | 0.000E+00 | 0.000E+00 |
| 26th Coefficient(N) | 0.000E+00 | 0.000E+00 | 0.000E+00 | 0.000E+00 | 0.000E+00 | 0.000E+00 |
| 28th Coefficient(O) | 0.000E+00 | 0.000E+00 | 0.000E+00 | 0.000E+00 | 0.000E+00 | 0.000E+00 |
| 30th Coefficient(P) | 0.000E+00 | 0.000E+00 | 0.000E+00 | 0.000E+00 | 0.000E+00 | 0.000E+00 |

### Seventh Embodiment

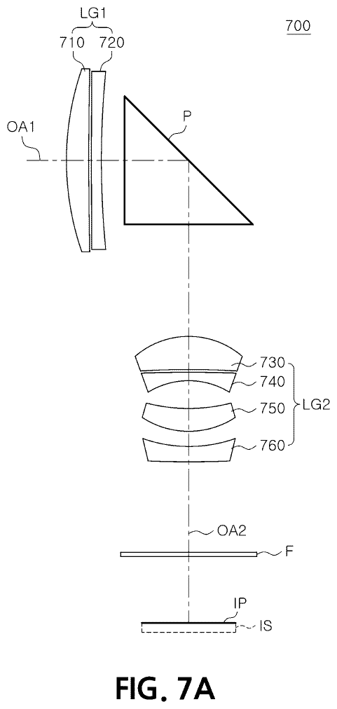

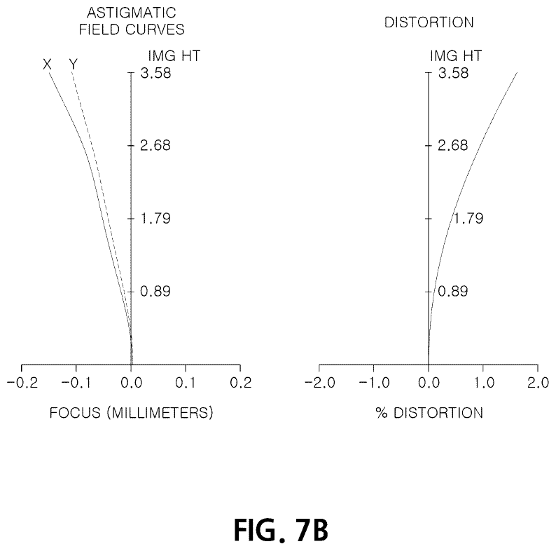

FIG. 7A is a configuration diagram of an optical imaging system according to a seventh embodiment of the present disclosure, and FIG. 7B is a graph illustrating aberration characteristics of an optical imaging system according to a seventh embodiment of the present disclosure.

An optical imaging system 700 according to a seventh embodiment of the present disclosure may include a first lens 710, a second lens 720, a third lens 730, a fourth lens 740, a fifth lens 750, and a sixth lens 760, disposed in order from an object side. In addition, a filter F and an image sensor IS having an imaging plane IP may be disposed on an image side of the sixth lens 760. In addition, although not illustrated in the drawing, a stop may be disposed between the fourth lens 740 and the fifth lens 750.

The optical imaging system 700 according to the seventh embodiment of the present disclosure may include a first lens group LG1 and a second lens group LG2, and an optical path changing member P may be disposed between the first lens group LG1 and the second lens group LG2. For example, the first lens group LG1 and the second lens group LG2 may have different optical axes.

According to the seventh embodiment of the present disclosure, the first lens group LG1 may include the first lens 710 and the second lens 720, arranged in a first optical axis OA1 direction. The second lens group LG2 may include the third lens 730, the fourth lens 740, the fifth lens 750, and the sixth lens 760, arranged in a second optical axis OA2 direction. The optical path changing member P may change a path of incident light incident in the first optical axis OA1 direction to the second optical axis OA2 direction.

Characteristics of each of the lenses constituting the optical imaging system 700 according to the seventh embodiment of the present disclosure are as illustrated in Table 13.

TABLE 13

| | | Radius of | Thickness/ | Refractive | Abbe | Effective Radius | |
|---|---|---|---|---|---|---|---|
| Surface No. | | Curvature | Distance | Index | Number | X-axis | Y-axis |
| S1 | 1^{st} Lens | 12.498 | 0.972 | 1.535 | 55.7 | 4.000 | 4.000 |
| S2 | | 715.957 | 0.097 | | | 3.948 | 3.948 |
| S3 | 2^{nd} Lens | 494.294 | 0.432 | 1.614 | 25.9 | 3.923 | 3.923 |
| S4 | | 39.858 | 0.900 | | | 3.838 | 3.838 |
| S5 | Prism | Infinity | 2.900 | 1.717 | 29.5 | | |
| S6 | | Infinity | 2.900 | 1.717 | 29.5 | | |
| S7 | | Infinity | 5.000 | | | | |
| S8 | 3^{rd} Lens | 3.449 | 1.457 | 1.535 | 55.7 | 2.300 | 1.750 |
| S9 | | 24.988 | 0.121 | | | 2.081 | 1.750 |
| S10 | 4^{th} Lens | 26.382 | 0.400 | 1.614 | 25.9 | 2.022 | 1.750 |
| S11 | | 3.351 | 1.244 | | | 1.749 | 1.750 |
| S12 | 5^{th} Lens | −6.260 | 1.000 | 1.661 | 20.4 | 1.824 | 1.750 |
| S13 | | −3.387 | 0.661 | | | 1.998 | 1.750 |
| S14 | 6^{th} Lens | −14.321 | 0.700 | 1.639 | 23.5 | 1.985 | 1.750 |
| S15 | | 19.756 | 4.000 | | | 2.200 | 1.750 |
| S16 | Filter | Infinity | 0.210 | 1.517 | 64.2 | | |
| S17 | | Infinity | 2.973 | | | | |
| S18 | Imaging | Infinity | | | | | |
| | Plane | | | | | | |

According to the seventh embodiment of the present disclosure, the first lens 710 may have positive refractive power, an object-side surface may be convex, and an image-side surface may be concave. The second lens 720 may have negative refractive power, an object-side surface may be convex, and an image-side surface may be concave. The third lens 730 may have positive refractive power, an object-side surface may be convex, and an image-side surface may be concave. The fourth lens 740 may have negative refractive power, an object-side surface may be convex, and an image-side surface may be concave. The fifth lens 750 may have positive refractive power, an object-side surface may be concave, and an image-side surface may be convex. The sixth lens 760 may have negative refractive power, and both an object-side surface and an image-side surface may be concave.

In addition, according to the seventh embodiment of the present disclosure, among the first lens 710 to the sixth lens 760, the third lens 730 may be the thickest lens, and the fifth lens 750 may be a lens having the highest refractive index. For example, a refractive index of the fifth lens 750 may be 1.65 or more. In addition, among the first lens 710 to the sixth lens 760, the third lens 730 to the sixth lens 760 may all be D-cut lenses.

Aspherical coefficients of each of the lenses constituting the optical imaging system 700 according to the seventh embodiment of the present disclosure are as illustrated in Table 14. According to the seventh embodiment, at least one of the object-side surface or the image-side surface of the first lens 710 to the sixth lens 760 may be aspherical.

TABLE 14

| Surface No. | S1 | S2 | S3 | S4 | S8 | S9 |
|---|---|---|---|---|---|---|
| Conic Constant(K) | −0.274 | 0.000 | −1.000 | −17.787 | 0.000 | 0.037 |
| 4th Coefficient(A) | −4.633E−05 | 1.607E−05 | 5.080E−06 | −4.798E−05 | 5.023E−04 | −9.839E−04 |
| 6th Coefficient(B) | −1.785E−06 | −9.465E−07 | 1.352E−07 | −9.053E−07 | −4.077E−05 | 1.795E−02 |
| 8th Coefficient(C) | 2.245E−08 | −6.877E−08 | −6.108E−08 | 5.938E−08 | −1.378E−05 | −2.497E−02 |
| 10th Coefficient(D) | 0.000E+00 | 0.000E+00 | 0.000E+00 | 0.000E+00 | −2.971E−06 | 1.822E−02 |
| 12th Coefficient(E) | 0.000E+00 | 0.000E+00 | 0.000E+00 | 0.000E+00 | 0.000E+00 | −8.266E−03 |
| 14th Coefficient(F) | 0.000E+00 | 0.000E+00 | 0.000E+00 | 0.000E+00 | 0.000E+00 | 2.371E−03 |
| 16th Coefficient(G) | 0.000E+00 | 0.000E+00 | 0.000E+00 | 0.000E+00 | 0.000E+00 | −4.177E−04 |
| 18th Coefficient(H) | 0.000E+00 | 0.000E+00 | 0.000E+00 | 0.000E+00 | 0.000E+00 | 4.127E−05 |
| 20th Coefficient(J) | 0.000E+00 | 0.000E+00 | 0.000E+00 | 0.000E+00 | 0.000E+00 | −1.750E−06 |
| 22nd Coefficient(L) | 0.000E+00 | 0.000E+00 | 0.000E+00 | 0.000E+00 | 0.000E+00 | 0.000E+00 |
| 24th Coefficient(M) | 0.000E+00 | 0.000E+00 | 0.000E+00 | 0.000E+00 | 0.000E+00 | 0.000E+00 |
| 26th Coefficient(N) | 0.000E+00 | 0.000E+00 | 0.000E+00 | 0.000E+00 | 0.000E+00 | 0.000E+00 |
| 28th Coefficient(O) | 0.000E+00 | 0.000E+00 | 0.000E+00 | 0.000E+00 | 0.000E+00 | 0.000E+00 |
| 30th Coefficient(P) | 0.000E+00 | 0.000E+00 | 0.000E+00 | 0.000E+00 | 0.000E+00 | 0.000E+00 |

| Surface No. | S10 | S11 | S12 | S13 | S14 | S15 |
|---|---|---|---|---|---|---|
| Conic Constant(K) | 1.000 | −0.701 | 0.000 | −0.913 | 0.000 | 8.612 |
| 4th Coefficient(A) | −1.234E−06 | 9.692E−03 | 0.000E+00 | 2.848E−03 | −8.067E−03 | −1.340E−02 |
| 6th Coefficient(B) | −1.154E−04 | −4.036E−02 | 0.000E+00 | 2.598E−03 | −1.123E−03 | 5.038E−04 |
| 8th Coefficient(C) | −3.089E−05 | 7.021E−02 | 0.000E+00 | −5.953E−03 | −6.417E−05 | −6.157E−05 |
| 10th Coefficient(D) | −2.236E−06 | −6.775E−02 | 0.000E+00 | 5.298E−03 | 1.703E−05 | 2.912E−06 |
| 12th Coefficient(E) | 0.000E+00 | 4.099E−02 | 0.000E+00 | −2.868E−03 | −2.787E−06 | 0.000E+00 |
| 14th Coefficient(F) | 0.000E+00 | −1.573E−02 | 0.000E+00 | 9.634E−04 | 0.000E+00 | 0.000E+00 |
| 16th Coefficient(G) | 0.000E+00 | 3.721E−03 | 0.000E+00 | −1.963E−04 | 0.000E+00 | 0.000E+00 |
| 18th Coefficient(H) | 0.000E+00 | −4.951E−04 | 0.000E+00 | 2.219E−05 | 0.000E+00 | 0.000E+00 |
| 20th Coefficient(J) | 0.000E+00 | 2.835E−05 | 0.000E+00 | −1.070E−06 | 0.000E+00 | 0.000E+00 |
| 22nd Coefficient(L) | 0.000E+00 | 0.000E+00 | 0.000E+00 | 0.000E+00 | 0.000E+00 | 0.000E+00 |
| 24th Coefficient(M) | 0.000E+00 | 0.000E+00 | 0.000E+00 | 0.000E+00 | 0.000E+00 | 0.000E+00 |
| 26th Coefficient(N) | 0.000E+00 | 0.000E+00 | 0.000E+00 | 0.000E+00 | 0.000E+00 | 0.000E+00 |
| 28th Coefficient(O) | 0.000E+00 | 0.000E+00 | 0.000E+00 | 0.000E+00 | 0.000E+00 | 0.000E+00 |
| 30th Coefficient(P) | 0.000E+00 | 0.000E+00 | 0.000E+00 | 0.000E+00 | 0.000E+00 | 0.000E+00 |

### Eighth Embodiment

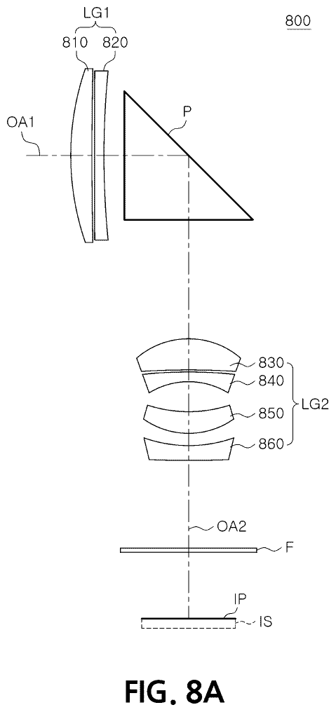

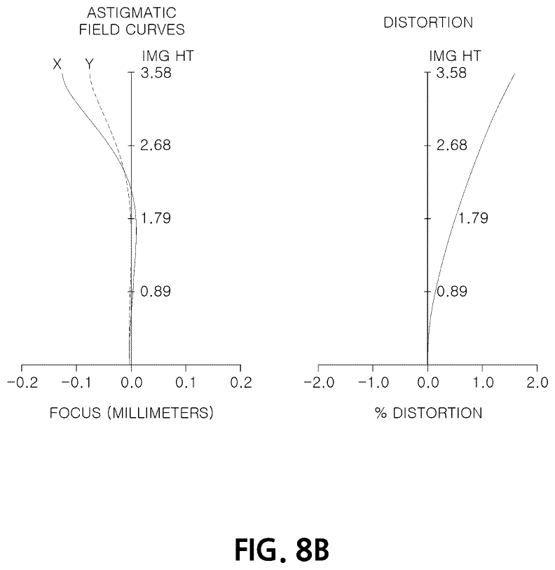

FIG. 8A is a configuration diagram of an optical imaging system according to an eighth embodiment of the present disclosure, and FIG. 8B is a graph illustrating aberration characteristics of an optical imaging system according to an eighth embodiment of the present disclosure.

An optical imaging system 800 according to an eighth embodiment of the present disclosure may include a first lens 810, a second lens 820, a third lens 830, a fourth lens 840, a fifth lens 850, and a sixth lens 860, disposed in order from an object side. In addition, a filter F and an image sensor IS having an imaging plane IP may be disposed on an image side of the sixth lens 860. In addition, although not illustrated in the drawing, a stop may be disposed between the fourth lens 840 and the fifth lens 850.

The optical imaging system 800 according to the eighth embodiment of the present disclosure may include a first lens group LG1 and a second lens group LG2, and an optical path changing member P may be disposed between the first lens group LG1 and the second lens group LG2. For example, the first lens group LG1 and the second lens group LG2 may have different optical axes.

According to the eighth embodiment of the present disclosure, the first lens group LG1 may include the first lens 810 and the second lens 820, arranged in a first optical axis OA1 direction. The second lens group LG2 may include the third lens 830, the fourth lens 840, the fifth lens 850, and the sixth lens 860, arranged in a second optical axis OA2 direction. The optical path changing member P may change a path of incident light incident in the first optical axis OA1 direction to the second optical axis OA2 direction.

Characteristics of each of the lenses constituting the optical imaging system 800 according to the eighth embodiment of the present disclosure are as illustrated in Table 15.

TABLE 15

| | | Radius of | Thickness/ | Refractive | Abbe | Effective Radius | |
|---|---|---|---|---|---|---|---|
| Surface No. | | Curvature | Distance | Index | Number | X-axis | Y-axis |
| S1 | 1^{st} Lens | 11.789 | 0.983 | 1.535 | 55.7 | 4.000 | 4.000 |
| S2 | | 217.446 | 0.100 | | | 3.945 | 3.945 |
| S3 | 2^{nd} Lens | 179.371 | 0.417 | 1.614 | 25.9 | 3.920 | 3.920 |
| S4 | | 33.129 | 0.900 | | | 3.833 | 3.833 |
| S5 | Prism | Infinity | 2.900 | 1.717 | 29.5 | | |
| S6 | | Infinity | 2.900 | 1.717 | 29.5 | | |
| S7 | | Infinity | 5.500 | | | | |
| S8 | 3^{rd} Lens | 3.440 | 1.397 | 1.535 | 55.7 | 2.300 | 1.750 |
| S9 | | 23.580 | 0.100 | | | 2.104 | 1.750 |
| S10 | 4^{th} Lens | 20.897 | 0.433 | 1.614 | 25.9 | 2.040 | 1.750 |
| S11 | | 3.422 | 1.375 | | | 1.750 | 1.750 |
| S12 | 5^{th} Lens | −5.562 | 1.000 | 1.661 | 20.4 | 1.823 | 1.750 |
| S13 | | −3.100 | 0.540 | | | 1.990 | 1.750 |
| S14 | 6^{th} Lens | −9.984 | 0.700 | 1.639 | 23.5 | 1.978 | 1.750 |
| S15 | | 24.855 | 4.000 | | | 2.200 | 1.750 |
| S16 | Filter | Infinity | 0.210 | 1.517 | 64.2 | | |
| S17 | | Infinity | 2.755 | | | | |
| S18 | Imaging | Infinity | | | | | |
| | Plane | | | | | | |

According to the eighth embodiment of the present disclosure, the first lens 810 may have positive refractive power, an object-side surface may be convex, and an image-side surface may be concave. The second lens 820 may have negative refractive power, an object-side surface may be convex, and an image-side surface may be concave. The third lens 830 may have positive refractive power, an object-side surface may be convex, and an image-side surface may be concave. The fourth lens 840 may have negative refractive power, an object-side surface may be convex, and an image-side surface may be concave. The fifth lens 850 may have positive refractive power, an object-side surface may be concave, and an image-side surface may be convex. The sixth lens 860 may have negative refractive power, and both an object-side surface and an image-side surface may be concave.

In addition, according to the eighth embodiment of the present disclosure, among the first lens 810 to the sixth lens 860, the third lens 830 may be the thickest lens, and the fifth lens 850 may be a lens having the highest refractive index. For example, a refractive index of the fifth lens 850 may be 1.65 or more. In addition, among the first lens 810 to the sixth lens 860, the third lens 830 to the sixth lens 860 may all be D-cut lenses.

Aspherical coefficients of each of the lenses constituting the optical imaging system 800 according to the eighth embodiment of the present disclosure are as illustrated in Table 16. According to the eighth embodiment, at least one of the object-side surface or the image-side surface of the first lens 810 to the sixth lens 860 may be aspherical.

TABLE 16

| Surface No. | S1 | S2 | S3 | S4 | S8 | S9 |
|---|---|---|---|---|---|---|
| Conic Constant(K) | −0.400 | 0.000 | 1.000 | −17.144 | 0.000 | 0.037 |
| 4th Coefficient(A) | −5.639E−05 | 1.582E−05 | 4.553E−06 | −5.396E−05 | 7.184E−04 | 1.008E−03 |
| 6th Coefficient(B) | −2.277E−06 | −4.383E−07 | 4.187E−07 | −8.409E−07 | −3.607E−05 | 1.257E−02 |
| 8th Coefficient(C) | 7.861E−08 | −2.099E−08 | −3.932E−08 | 6.491E−08 | −2.040E−05 | −1.754E−02 |
| 10th Coefficient(D) | 0.000E+00 | 0.000E+00 | 0.000E+00 | 0.000E+00 | −3.887E−06 | 1.232E−02 |
| 12th Coefficient(E) | 0.000E+00 | 0.000E+00 | 0.000E+00 | 0.000E+00 | 0.000E+00 | −5.448E−03 |
| 14th Coefficient(F) | 0.000E+00 | 0.000E+00 | 0.000E+00 | 0.000E+00 | 0.000E+00 | 1.540E−03 |
| 16th Coefficient(G) | 0.000E+00 | 0.000E+00 | 0.000E+00 | 0.000E+00 | 0.000E+00 | −2.688E−04 |
| 18th Coefficient(H) | 0.000E+00 | 0.000E+00 | 0.000E+00 | 0.000E+00 | 0.000E+00 | 2.638E−05 |
| 20th Coefficient(J) | 0.000E+00 | 0.000E+00 | 0.000E+00 | 0.000E+00 | 0.000E+00 | −1.114E−06 |
| 22nd Coefficient(L) | 0.000E+00 | 0.000E+00 | 0.000E+00 | 0.000E+00 | 0.000E+00 | 0.000E+00 |
| 24th Coefficient(M) | 0.000E+00 | 0.000E+00 | 0.000E+00 | 0.000E+00 | 0.000E+00 | 0.000E+00 |
| 26th Coefficient(N) | 0.000E+00 | 0.000E+00 | 0.000E+00 | 0.000E+00 | 0.000E+00 | 0.000E+00 |
| 28th Coefficient(O) | 0.000E+00 | 0.000E+00 | 0.000E+00 | 0.000E+00 | 0.000E+00 | 0.000E+00 |
| 30th Coefficient(P) | 0.000E+00 | 0.000E+00 | 0.000E+00 | 0.000E+00 | 0.000E+00 | 0.000E+00 |

| Surface No. | S10 | S11 | S12 | S13 | S14 | S15 |
|---|---|---|---|---|---|---|
| Conic Constant(K) | 1.000 | −0.665 | 0.000 | −1.042 | 0.000 | −16.519 |
| 4th Coefficient(A) | 1.577E−05 | 5.594E−03 | 0.000E+00 | 6.043E−03 | −6.850E−03 | −1.372E−02 |
| 6th Coefficient(B) | −1.038E−04 | −2.570E−02 | 0.000E+00 | −2.142E−03 | −1.292E−03 | 6.437E−04 |
| 8th Coefficient(C) | −2.613E−05 | 4.383E−02 | 0.000E+00 | −1.219E−04 | −1.152E−04 | −7.071E−05 |
| 10th Coefficient(D) | −2.077E−06 | −4.023E−02 | 0.000E+00 | 6.030E−04 | 2.604E−05 | 5.223E−06 |
| 12th Coefficient(E) | 0.000E+00 | 2.342E−02 | 0.000E+00 | −4.769E−04 | −6.275E−07 | 0.000E+00 |
| 14th Coefficient(F) | 0.000E+00 | −8.706E−03 | 0.000E+00 | 1.906E−04 | 0.000E+00 | 0.000E+00 |
| 16th Coefficient(G) | 0.000E+00 | 2.003E−03 | 0.000E+00 | −4.231E−05 | 0.000E+00 | 0.000E+00 |
| 18th Coefficient(H) | 0.000E+00 | −2.601E−04 | 0.000E+00 | 4.969E−06 | 0.000E+00 | 0.000E+00 |
| 20th Coefficient(J) | 0.000E+00 | 1.458E−05 | 0.000E+00 | −2.417E−07 | 0.000E+00 | 0.000E+00 |
| 22nd Coefficient(L) | 0.000E+00 | 0.000E+00 | 0.000E+00 | 0.000E+00 | 0.000E+00 | 0.000E+00 |
| 24th Coefficient(M) | 0.000E+00 | 0.000E+00 | 0.000E+00 | 0.000E+00 | 0.000E+00 | 0.000E+00 |
| 26th Coefficient(N) | 0.000E+00 | 0.000E+00 | 0.000E+00 | 0.000E+00 | 0.000E+00 | 0.000E+00 |
| 28th Coefficient(O) | 0.000E+00 | 0.000E+00 | 0.000E+00 | 0.000E+00 | 0.000E+00 | 0.000E+00 |
| 30th Coefficient(P) | 0.000E+00 | 0.000E+00 | 0.000E+00 | 0.000E+00 | 0.000E+00 | 0.000E+00 |

Table 17 shows optical and physical characteristics of the optical imaging system according to embodiments of the present disclosure, and Table 18 shows conditional expression values according to embodiments of the present disclosure.

TABLE 17

| | Embodiment 1 | Embodiment 2 | Embodiment 3 | Embodiment 4 |
|---|---|---|---|---|
| f | 18.609 | 18.612 | 18.610 | 18.610 |
| f1 | −56.290 | −63.922 | 24.365 | 20.198 |
| f2 | 19.7460 | 20.1128 | −70.175 | −57.765 |
| f3 | 7.610 | 8.143 | 6.826 | 7.541 |
| f4 | −6.064 | −6.645 | −5.246 | −5.758 |
| f5 | 6.619 | 7.604 | 7.042 | 7.100 |
| f6 | −7.364 | −8.704 | −9.587 | −9.097 |
| fG1 | 31.041 | 30.051 | 36.076 | 30.061 |
| fG2 | 49.852 | 50.834 | 32.578 | 44.976 |
| F-number | 3.048 | 3.154 | 3.116 | 3.086 |
| FOV | 21.433 | 21.475 | 21.358 | 21.467 |
| imh | 3.575 | 3.575 | 3.575 | 3.575 |
| OAL | 24.726 | 24.727 | 21.644 | 24.760 |
| BFL | 6.902 | 7.030 | 7.533 | 7.008 |
| dG1G2 | 11.020 | 11.020 | 10.900 | 11.020 |
| h1 | 8.000 | 8.000 | 8.000 | 8.000 |
| h2 | 3.500 | 3.500 | 3.500 | 3.500 |
| | Embodiment 5 | Embodiment 6 | Embodiment 7 | Embodiment 8 |
| f | 18.607 | 18.614 | 18.612 | 18.614 |
| f1 | 24.325 | 23.269 | 23.773 | 23.269 |
| f2 | −94.716 | −66.203 | −70.583 | −66.203 |
| f3 | 6.266 | 7.355 | 7.308 | 7.355 |
| f4 | −4.533 | −6.723 | −6.289 | −6.723 |
| f5 | 6.563 | 9.125 | 9.811 | 9.125 |
| f6 | −9.644 | −11.058 | −12.886 | −11.058 |
| fG1 | 32.090 | 34.988 | 35.073 | 34.988 |
| fG2 | 35.872 | 31.806 | 32.923 | 31.806 |
| F-number | 3.028 | 2.979 | 3.045 | 2.979 |
| FOV | 21.465 | 21.406 | 21.427 | 21.406 |
| imh | 3.575 | 3.575 | 3.575 | 3.575 |
| OAL | 25.2990 | 26.210 | 25.965 | 26.210 |
| BFL | 7.428 | 6.965 | 7.183 | 6.965 |
| dG1G2 | 10.900 | 12.200 | 11.700 | 12.200 |
| h1 | 8.000 | 8.000 | 8.000 | 8.000 |
| h2 | 3.500 | 3.500 | 3.500 | 3.500 |

TABLE 18

| | Embodiment 1 | Embodiment 2 | Embodiment 3 | Embodiment 4 |
|---|---|---|---|---|
| \|f/f1\| + \|f/f2\| | 1.273 | 1.216 | 1.029 | 1.244 |
| fG1/f | 1.668 | 1.615 | 1.939 | 1.615 |
| fG1/fG2 | 0.623 | 0.591 | 1.107 | 0.668 |
| h1/h2 | 2.286 | 2.286 | 2.286 | 2.286 |
| dG1G2/OAL | 0.446 | 0.446 | 0.428 | 0.445 |
| h2/F-number | 1.148 | 1.110 | 1.123 | 1.134 |
| f1/f2 | −2.851 | −3.176 | −0.347 | −0.350 |
| f/f1 | −0.331 | −0.291 | 0.764 | 0.921 |
| f/f2 | 0.942 | 0.925 | −0.265 | −0.322 |
| f/f3 | 2.445 | 2.286 | 2.726 | 2.468 |
| f/f4 | −3.069 | −2.801 | −3.548 | −3.232 |
| f/f5 | 2.811 | 2.448 | 2.643 | 2.621 |
| f/f6 | −2.527 | −2.138 | −1.941 | −2.046 |
| | Embodiment 5 | Embodiment 6 | Embodiment 7 | Embodiment 8 |
| \|f/f1\| + \|f/f2\| | 1.228 | 0.961 | 1.047 | 1.081 |
| fG1/f | 1.669 | 1.725 | 1.884 | 1.880 |
| fG1/fG2 | 0.695 | 0.895 | 1.065 | 1.100 |
| h1/f2 | 2.286 | 2.286 | 2.286 | 2.286 |
| dG1G2/OAL | 0.439 | 0.431 | 0.451 | 0.465 |
| h2/F-number | 1.102 | 1.156 | 1.149 | 1.175 |
| f1/f2 | −0.357 | −0.257 | −0.337 | −0.351 |
| f/f1 | 0.905 | 0.765 | 0.783 | 0.800 |
| f/f2 | −0.323 | −0.196 | −0.264 | −0.281 |
| f/f3 | 2.421 | 2.970 | 2.547 | 2.531 |
| f/f4 | −2.758 | −4.105 | −2.960 | −2.769 |
| f/f5 | 2.419 | 2.835 | 1.897 | 2.040 |
| f/f6 | −2.206 | −1.929 | −1.444 | −1.683 |

According to embodiments of the present disclosure, low-light performance of a telephoto camera may be improved while minimizing an increase in a height of a module. Furthermore, a clear image may be obtained even in a high magnification mode.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens group including a first lens and a second lens, sequentially disposed in a first optical axis direction from an object side;
a second lens group including a third lens, a fourth lens, a fifth lens, and a sixth lens, sequentially disposed in a second optical axis direction, perpendicular to the first optical axis direction; and
an optical path changing member disposed between the first lens group and the second lens group configured to change a propagation direction of light from the first optical axis direction to the second optical axis direction,
wherein the optical imaging system satisfies a conditional expression of 0.5≤|f/f1|+|f/f2|≤2.0, where f is a focal length of the optical imaging system, f1 is a focal length of the first lens, and f2 is a focal length of the second lens.

2. The optical imaging system of claim 1, wherein the first lens and the second lens have opposite refractive powers.

3. The optical imaging system of claim 1, wherein a conditional expression of 1≤fG1/f≤3 is satisfied, where fG1 is a focal length of the first lens group.

4. The optical imaging system of claim 1, wherein a conditional expression of 0.3≤fG1/fG2≤2.0 is satisfied, where fG1 is a focal length of the first lens group, and fG2 is a focal length of the second lens group.

5. The optical imaging system of claim 1, wherein a conditional expression of 0.5≤h2/F-number≤2 is satisfied, where h2 is a maximum length of the second lens group in the first optical axis direction.

6. The optical imaging system of claim 1, wherein the third lens has positive refractive power, the fourth lens has negative refractive power, the fifth lens has positive refractive power, and the sixth lens has negative refractive power.

7. The optical imaging system of claim 1, wherein an image-side surface of the third lens is concave, and an object-side surface of the fourth lens is convex.

8. The optical imaging system of claim 1, wherein an image-side surface of the third lens is convex, and an object-side surface of the fourth lens is concave.

9. The optical imaging system of claim 1, wherein an object-side surface of the fifth lens is concave, and an image-side surface of the fifth lens is convex.

10. The optical imaging system of claim 1, wherein an image-side surface of the first lens and an image-side surface of the sixth lens are concave.

11. The optical imaging system of claim 1, wherein an image-side surface of the first lens and an image-side surface of the sixth lens are convex.

12. An optical imaging system comprising:
an optical path changing member;
a first lens group disposed on an object side of the optical path changing member and including a plurality of lenses disposed in a first optical axis direction; and
a second lens group disposed on an image side of the optical path changing member and including a plurality of lenses disposed in a second optical axis direction, perpendicular to the first optical axis direction,
wherein the number of lenses in the second lens group is greater than the number of lenses in the first lens group, and
wherein the optical imaging system satisfies a conditional expression of 0.3≤fG1/fG2≤2.0, where fG1 is a focal length of the first lens group, and fG2 is a focal length of the second lens group.

13. The optical imaging system of claim 12, wherein the first lens group includes a first lens having positive refractive power and a second lens having negative refractive power, and
wherein the second lens group includes a third lens having positive refractive power, a fourth lens having negative refractive power, a fifth lens having positive refractive power, and a sixth lens having negative refractive power.

14. The optical imaging system of claim 12, wherein the first lens group includes a first lens having negative refractive power and a second lens having positive refractive power, and
wherein the second lens group includes a third lens having positive refractive power, a fourth lens having negative refractive power, a fifth lens having positive refractive power, and a sixth lens having negative refractive power.

15. The optical imaging system of claim 12, wherein a conditional expression of 1≤h1/h2≤3 is satisfied, where h1 is a maximum length of the optical imaging system in the first optical axis direction, and h2 is a maximum length of the second lens group in the first optical axis direction.

16. The optical imaging system of claim 12, wherein a conditional expression of 0.5≤h2/F-number≤2 is satisfied, where h2 is a maximum length of the second lens group in the first optical axis direction.
